(19) United States
(12) Patent Application Publication
(10) Pub. No.: US 2024/0281823 A1
(43) Pub. Date: Aug. 22, 2024

(54) CUSTOMER SERVICE ROBOT AND METHOD

(71) Applicant: TOSHIBA TEC KABUSHIKI KAISHA, Tokyo (JP)

(72) Inventors: Yumiko Okuma, Koganei Tokyo (JP); Kizuku Inoue, Yokohama Kanagawa (JP); Kazuki Nakamura, Ota Tokyo (JP); Yousuke Otsuka, Nerima Tokyo (JP); Chisa Kokue, Ota Tokyo (JP); Hideyuki Wada, Ota Tokyo (JP); Shogo Watada, Numazu Shizuoka (JP); Naoki Hoshino, Hasuda Saitama (JP); Sayaka Shimokawa, Yokohama Kanagawa (JP)

(21) Appl. No.: 18/406,255

(22) Filed: Jan. 8, 2024

(30) Foreign Application Priority Data
Feb. 22, 2023 (JP) 2023-025808

(51) Int. Cl. G06Q 30/015; G05D 1/243; G05D 1/686

(52) U.S. Cl. CPC G06Q 30/015; G05D 1/243; G05D 1/686; G05D 2101/20; G05D 2107/67

(57) ABSTRACT

A customer service robot autonomously moves to support shopping of a customer in a commercial facility including a plurality of stores. The customer service robot includes an operation mode setting unit (a moving form setting unit) that sets a moving form in moving while being accompanied by the customer to a leading mode (a first moving form) for leading the customer and moving along a set moving route or a following mode (a second moving form) for moving following the customer and a movement control unit that causes the customer service robot to move, in the moving form set by the operation mode setting unit, in a state in which the distance to the customer is kept constant.

### CROSS-REFERENCE TO RELATED APPLICATION

This application is based upon and claims the benefit of priority from Japanese Patent Application No. 2023-025808, filed Feb. 22, 2023, the entire contents of which are incorporated herein by reference.

### FIELD

Embodiments described herein relate generally to a customer service robot and a method.

### BACKGROUND

There has been proposed a robot that performs customer service for a customer who visits a store (hereinafter referred to as customer service robot). For example, there has been proposed a self-propelled robot that guides, to the position of a commodity, a customer who cannot specify a display place of the commodity in a store.

In a disclosed customer attendance system, a form of the customer service performed by the customer service robot is limited to a form in which the customer service robot leads (guides) and attends the customer. However, some customer desires to go ahead and tour around the store. Therefore, there has been a demand for implementing a customer service form meeting a desire of a customer.

### BRIEF DESCRIPTION OF THE DRAWINGS

FIG. 1 is a diagram illustrating an example of a configuration of a customer service support system according to an embodiment;

FIG. 2 is a front perspective view illustrating an example of a customer service robot according to the embodiment;

FIG. 3 is a rear perspective view illustrating the example of the customer service robot;

FIG. 4 is a diagram illustrating an example of a hardware configuration of the customer service robot;

FIG. 5 is a diagram illustrating an example of a hardware configuration of a store device according to the embodiment;

FIG. 6 is a diagram illustrating an example of a data configuration of a commodity master;

FIG. 7 is a diagram illustrating an example of a hardware configuration of a server device according to the embodiment;

FIG. 8 is a diagram illustrating an example of a data configuration of a store management table;

FIG. 9 is a diagram illustrating an example of a data configuration of a robot management table;

FIG. 10 is a diagram illustrating an example of a data configuration of a user management table;

FIG. 11 is a diagram illustrating an example of a data configuration of a transaction management table;

FIG. 12 is a functional block diagram illustrating an example of functional configurations of the customer service robot, the store device, and the server device;

FIG. 13 is a diagram illustrating an example of a state in which the customer service robot is leading a customer in a leading mode;

FIG. 14 is a diagram illustrating an example of a state in which the customer service robot is following the customer in a following mode;

FIG. 15 is a diagram for explaining a handover function of the customer service robot;

FIG. 16 is a diagram illustrating an example of a check-in screen displayed on a front display unit of the customer service robot at a check-in time;

FIG. 17 is a diagram illustrating an example of a screen displayed on the front display unit of the customer service robot if the customer instructs a store visiting purpose;

FIG. 18 is a diagram illustrating an example of a screen displayed on the front display unit of the customer service robot if the customer selects a store that the customer desires to visit;

FIG. 19 is a diagram illustrating an example of schematic information of a generated moving route displayed on the front display unit of the customer service robot;

FIG. 20 is a diagram illustrating an example of a screen displayed on the front display unit if the customer service robot is operating in the leading mode;

FIG. 21 is a diagram illustrating an example of a screen displayed on a rear display unit if the customer service robot is operating in the leading mode;

FIG. 22 is a diagram illustrating an example of a screen displayed on the front display unit if the customer service robot is operating in the following mode;

FIG. 23 is a diagram illustrating an example of a screen displayed on the rear display unit if the customer service robot is operating in the following mode;

FIG. 24 is a diagram illustrating an example of a basic operation screen;

FIG. 25 is a diagram illustrating an example of a commodity screen;

FIG. 26 is a flowchart illustrating an example of a flow of processing performed by the customer service robot;

FIG. 27 is a flowchart illustrating an example of a flow of movement control processing;

FIG. 28 is a flowchart illustrating an example of a flow of handover processing;

FIG. 29 is a flowchart illustrating an example of a flow of store cooperation processing; and

FIG. 30 is a flowchart illustrating an example of a flow of purchase support processing.

### DETAILED DESCRIPTION

An aspect of embodiments is to provide a customer service robot and a method that can implement a customer service form meeting a desire of a customer.

A customer service robot in an embodiment is a robot that autonomously moves to support shopping of a customer in a commercial facility including a plurality of stores, the robot including a moving form setting unit and a movement control unit. The moving form setting unit sets a moving form in moving while being accompanied by the customer to a first moving form for leading the customer and moving along a set moving route or a second moving form for moving following the customer. The movement control unit causes the customer service robot to move, in the moving form set by the moving form setting unit, in a state in which a distance to the customer is kept constant.

An embodiment is explained in detail below with reference to the drawings. In the embodiment explained below, a form in which a customer service support system 1 is applied to a commercial facility such as a shopping center or a station building where a plurality of stores are accommodated. Note that embodiments are not limited by the embodiment explained below.

### (System Configuration of the Customer Service Support System)

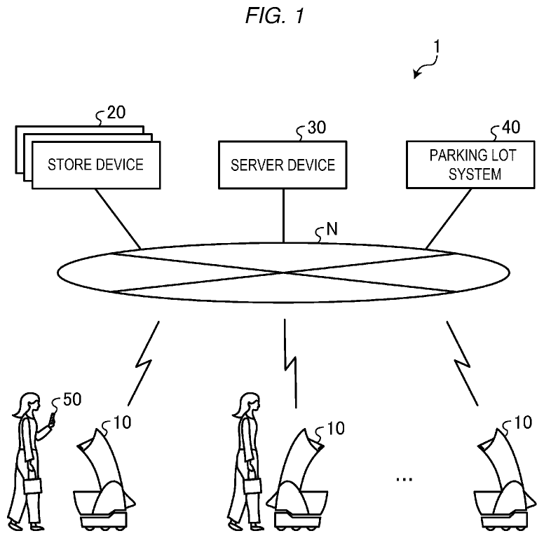

FIG. 1 is a diagram illustrating an example of a configuration of the customer service support system according to the embodiment. As illustrated in FIG. 1, the customer service support system 1 includes a customer service robot 10, a store device 20, a server device 30, a parking lot system 40, and a customer terminal 50. The customer service robot 10, the store device 20, the server device 30, and the parking lot system 40 are connected to a network N such as a LAN (Local Area Network).

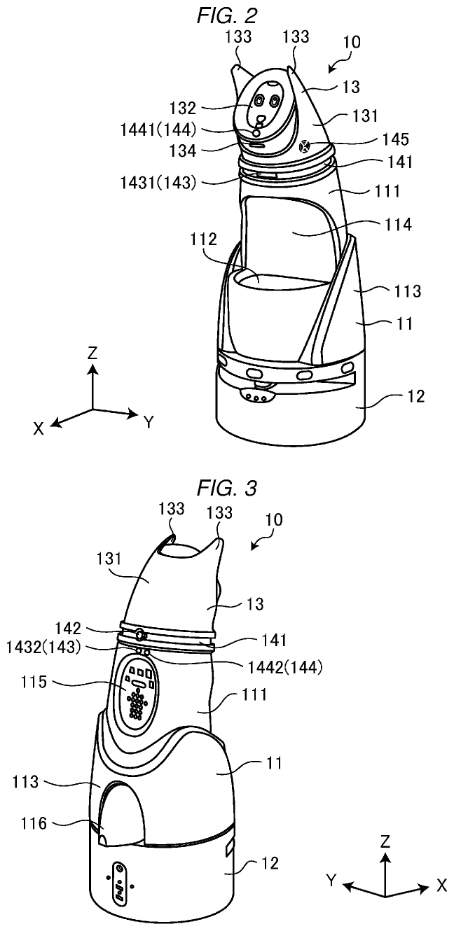

The customer service robot 10 is a mobile robot of an autonomously moving type. A plurality of customer service robots 10 are provided in the commercial facility and support actions of customers who use the commercial facility. Note that the number of the customer service robots 10 is not limited to the example illustrated in FIG. 1. A detailed configuration of the customer service robot 10 is explained below (see FIGS. 2 and 3).

The store device 20 is an information processing device such as a POS terminal or a store server provided in each of the stores present in the commercial facility. The store device 20 executes various kinds of processing relating to the store under control of a not-illustrated processor.

The server device 30 is a server device of the customer service support system 1. The server device 30 is implemented by an information processing device such as a PC (Personal Computer). The server device 30 stores and manages various data relating to data processing of the customer service support system 1. For example, the server device 30 manages a present position and an operation state of the customer service robot 10. For example, the server device 30 manages a commodity registered via the customer service robot 10 and a commodity purchased via the customer service robot 10.

Note that, in this embodiment, it is assumed that the server device 30 is implemented by a single information processing device. However, the server device 30 may be a Cloud server implemented by a plurality of information processing devices connected by a network. If the server device 30 is the Cloud server, the server device 30 may include store servers of the stores.

The parking lot system 40 is provided in a parking lot of the commercial facility and manages entering and leaving states and parking positions of vehicles. For example, the parking lot system 40 includes a gate device provided at an entrance of the parking lot, monitoring cameras provided to cover parking positions of the parking lot, and a parking lot management server (all of which are not illustrated) and manages parking positions and entering and leaving times based on registration numbers attached to vehicles (numbers described on number plates). For example, the parking lot management server recognizes a registration number of a vehicle from an image of the vehicle captured by the monitoring camera and stores the registration number in correlation with information indicating a parking position in the parking lot. The parking lot management server stores entering and leaving times of a vehicle obtained via the gate device in correlation with a vehicle registration number of the vehicle and collects a fee corresponding to a parking time via the gate device or the customer service robot 10.

The customer terminal 50 is a portable terminal device such as a smartphone or a tablet terminal carried by a customer. In this embodiment, the customer terminal 50 is used, for example, at a check-in operation time when the customer starts using the customer service robot 10. As an example, the check-in operation is performed by inputting a user ID capable of identifying the customer. Note that the customer service robot 10 can also be used even in a state in which the user ID is not input.

As an example, an application program relating to cooperation with the customer service robot 10 (hereinafter referred to as cooperation program as well) is introduced into the customer terminal 50. A processor of the customer terminal 50 cooperates with the cooperation program to execute various kinds of processing for cooperating with the customer service robot 10. For example, the processor of the customer terminal 50 causes, according to operation of the customer, a display device included in the customer terminal 50 to display a code symbol including a user ID. The processor of the customer terminal 50 is capable of establishing short-range wireless communication with the customer service robot 10 according to operation of the customer.

In the customer service support system 1 explained above, a customer visiting the commercial facility can enjoy customer service support by the customer service robot 10. Specifically, the customer can receive customer service support by the customer service robot 10 cooperating with the customer by operating the customer service robot 10. The customer service robot 10 executes various kinds of processing such as recommendation of a store to which the customer visits and support relating to purchase of a commodity while moving in the commercial facility together with the customer.

Note that the customer service support system 1 is not limited to the configuration illustrated in FIG. 1. For example, the customer terminal 50 may not be included in the customer service support system 1. External systems usable by the customer such as EC (Electronic Commerce) sites of stores present in the commercial facility, EC sites operated by other stores present outside the commercial facility, and various search sites may be included in the customer service support system 1. In this case, the customer service robot 10, the server device 30, and the like of the customer service support system 1 may be configured to be capable of referring to, based on a user ID or the like explained below, a purchase history of commodities purchased by the customer in the EC sites, a search history of matters searched by the customer in the search sites, and the like.

### (Configuration of the Customer Service Robot)

A configuration of the customer service robot 10 is explained with reference to FIGS. 2 and 3. FIG. 2 is a front exterior view illustrating an example of the customer service robot according to the embodiment. FIG. 3 is a rear exterior view illustrating the example of the customer service robot according to the embodiment.

The configuration of the customer service robot 10 is explained using three axial directions of an X axis, a Y axis, and a Z axis orthogonal to one another in FIGS. 2 and 3. The X axis is an axis piercing through the customer service robot 10 back and forth and extending from the rear to the front of the customer service robot 10. The Y axis is an axis piercing through the customer service robot 10 to the left and the right and extending from the left side to the right side if the customer service robot 10 is seen from the front. The Z axis is an axis piercing through the customer service robot 10 up and down and extending from the bottom to the top of the customer service robot 10. In the following explanation, an X-axis positive direction side of the customer service robot 10 is referred to as front side of the customer service robot 10 as well. An X-axis negative direction side of the customer service robot 10 is referred to as rear side of the customer service robot 10 as well.

The customer service robot 10 includes a main body unit 11, a moving unit 12, and an interface unit 13. The customer service robot 10 preferably has an exterior simulating a character such as an animal in order to give psychological sense of security to customers. The customer service robot 10 in this embodiment has an exterior simulating a kangaroo. The main body unit 11 and the moving unit 12 correspond to the body of the kangaroo and the interface unit 13 corresponds to the head of the kangaroo.

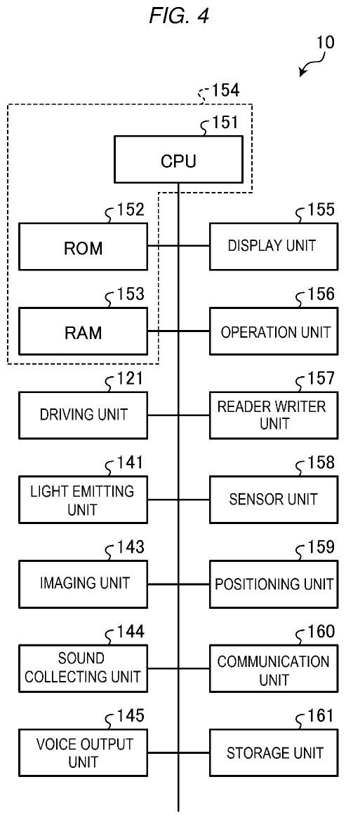

The main body unit 11 includes a substantially cylindrical housing 111, a placing table 112, and a cover unit 113 provided to cover the periphery of the placing table 112 from the lower rear side to the front side of the housing 111. An opening 114 is provided on the front side of the housing 111 to make it possible to access the inside of the housing 111 through the opening 114. The placing table 112 is provided in a state in which the placing table 112 projects from the inside of the housing 111 to the front side. An article such as a commodity can be placed on the placing table 112. A reader writer unit 157 (see FIG. 4) explained below may be provided in the placing table 112. The placing table 112 is designed to correspond to the brood pouch (bag) of the kangaroo in the exterior of the customer service robot 10.

In this embodiment, a part of the placing table 112 is projected from the housing 111. However, not only this, but the placing table 112 may be provided on the inside of the housing 111 to make it possible to store an article in the housing 111. An upward part of the placing table 112 is covered by the housing 111. However, not only this, but the upward part of the placing table 112 may not be covered.

An open-closable shielding member such as a lid or a door may be provided in the opening 114 to shield an article placed on the placing table 112. The shielding member may be formed of a light transmissive member such that a state of the inside can be viewed from the outside. Further, an electronic lock or the like may be provided to make it possible to lock a closed state by the shielding member. Consequently, it is possible to prevent the article from dropping from the placing table 112, for example, if the customer service robot 10 is moving. It is possible to prevent the article from being carelessly taken out from the placing table 112.

On the other hand, a rear display unit 115 is provided on the rear side of the housing 111. The rear display unit 115 is, for example, a touch panel display and displays various kinds of information under control of a control unit 154 explained below (see FIG. 4). A tail unit 116 corresponding to the tail of the kangaroo is provided in a rear side lower part of the housing 111. The rear display unit 115 is an example of a second display unit in the present disclosure.

The moving unit 12 is provided below the main body unit 11 and supports the main body unit 11 from below. The moving unit 12 includes a driving unit 121 (see FIG. 4) including a motor and a rotating mechanism. A plurality of driving wheels, a plurality of auxiliary wheels, and the like driven to rotate by the driving unit 121 (all of which are not illustrated) are provided on the bottom surface side of the moving unit 12.

The driving unit 121 is capable of causing the customer service robot 10 to travel by driving to rotate the driving wheels. Specifically, the driving unit 121 causes the customer service robot 10 to travel in any direction at any speed by changing rotating speed and a rotating direction of the driven driving and a driving source. Note that, in this embodiment, the driving unit 121 causes the customer service robot 10 to travel in a state in which the front side of the customer service robot 10 is directed to a traveling direction. However, not only this, but the driving unit 121 may cause the customer service robot 10 to travel in a state in which the rear side of the customer service robot 10 is directed to the traveling direction.

The interface unit 13 is provided above the main body unit 11. The interface unit 13 includes a housing 131 and a front display unit 132. An operation surface inclined to the front side is formed from the top to the bottom on the front side of the housing 131. The front display unit 132 is provided on the operation surface. The front display unit 132 is, for example, a touch panel display and displays various kinds of information under the control of the control unit 154 explained below. A pair of ear units 133 corresponding to the ears of the kangaroo is provided in the housing 131. Note that the front display unit 132 is an example of the first display unit in the present disclosure.

A slit 134 into which a commodity card explained below can be inserted is formed below the operation surface of the housing 111. A reader writer unit 157 (see FIG. 4) capable of reading and writing a wireless tag such as an RFID tag is provided on the inside of the slit 134. Under the control of the control unit 154 explained below, the reader writer unit 157 reads information capable of specifying a commodity from the wireless tag of the commodity card inserted into the slit 134 and writes, in the wireless tag, information indicating that a commodity was already purchased.

The customer service robot 10 includes a light emitting unit 141 between the main body unit 11 and the interface unit 13. The light emitting unit 141 includes a light emitting element such as an LED (Light Emitting Diode) and emits light according to the control of the control unit 154 explained below. The light emitting unit 141 includes light emitting elements of a plurality of colors and switches a light emission color according to the control of the control unit 154 explained below. The light emitting unit 141 emits light to thereby inform various states such as a state of the customer service robot 10 and a commodity purchase state. Note that, in this embodiment, an example is explained in which the light emitting unit 141 is provided in a collar shape in a position corresponding to the neck of the kangaroo. However, a position where the light emitting unit 141 is provided and a shape of the light emitting unit 141 are not limited to this.

The customer service robot 10 includes a stop button 142 on the rear side. The stop button 142 is an operation piece for stopping traveling of the customer service robot 10. If the stop button 142 was operated, the customer service robot 10 stops traveling. Note that, in this embodiment, an example is explained in which the stop button 142 is provided in a position corresponding to the neck of the kangaroo. However, a position where the stop button 142 is provided is not limited to this.

The customer service robot 10 includes a front imaging unit 1431 on the front side and includes a rear imaging unit 1432 on the rear side. The front imaging unit 1431 and the rear imaging unit 1432 include an imaging element such as a CCD (Charge Coupled Device) or a CMOS (Complementary MOS). The front imaging unit 1431 is an example of a first imaging unit in the present disclosure. The rear imaging unit 1432 is an example of a second imaging unit in the present disclosure.

The front imaging unit 1431 and the rear imaging unit 1432 image the periphery of the customer service robot 10 in order to grasp, for example, a customer present around the customer service robot 10 and an obstacle in a traveling direction of the customer service robot 10. The front imaging unit 1431 is also used to image a code symbol such as a barcode or a two-dimensional code attached to a commodity, a code symbol displayed on the customer terminal 50, and the like presented by the customer. In other words, the front imaging unit 1431 acquires the code symbol such as the barcode or the two-dimensional code attached to the commodity. Note that installation positions of the front imaging unit 1431 and the rear imaging unit 1432 included in the customer service robot 10 are not limited to an illustrated example. A plurality of front imaging units 1431 and a plurality of rear imaging units 1432 may be provided. In the following explanation, if the front imaging unit 1431 and the rear imaging unit 1432 are expressed without being distinguished, the front imaging unit 1431 and the rear imaging unit 1432 are sometimes simply referred to as imaging unit 143.

The customer service robot 10 includes a front sound collecting unit 1441 on the front side and includes a rear sound collecting unit 1442 on the rear side. The front sound collecting unit 1441 collects voice (for example, utterance of the customer) on the front side of the customer service robot 10. The rear sound collecting unit 1442 collects voice (for example, utterance of the customer) on the rear side of the customer service robot 10. The front sound collecting unit 1441 and the rear sound collecting unit 1442 are, for example, omni-directional microphones. Each of the front sound collecting unit 1441 and the rear sound collecting unit 1442 may be a microphone array in which a plurality of microphones are arranged in an array. For example, a directional characteristic of the microphone array configuring the front sound collecting unit 1441 is directed to a customer presence direction detected by the front imaging unit 1431, whereby the utterance of the customer can be more clearly collected. Similarly, a directional characteristic of the microphone array configuring the rear sound collecting unit 1442 is directed to a customer presence direction detected by the rear imaging unit 1432, whereby the utterance of the customer can be more clearly collected.

The customer service robot 10 includes a voice output unit 145. The voice output unit 145 outputs voice and sound of the customer service robot 10. The voice output unit 145 is, for example, a speaker. Note that the numbers and installation positions of the front sound collecting unit 1441, the rear sound collecting unit 1442, and the voice output unit 145 included in the customer service robot 10 are not limited to an illustrated example. In the following explanation, if the front sound collecting unit 1441 and the rear sound collecting unit 1442 are expressed without being distinguished, the front sound collecting unit 1441 and the rear sound collecting unit 1442 are sometimes simply referred to as sound collecting unit 144.

The customer service robot 10 includes various sensor units 158 (see FIG. 4). For example, the customer service robot 10 includes a distance measurement sensor. The distance measurement sensor is provided, for example, on each of the front side and the rear side of the customer service robot 10 and detects an object around the customer service robot 10 and detects a distance to the object. A sensing result of the distance measurement sensor is output to the control unit 154 explained below and used for, for example, collision avoidance at a traveling time. Note that the distance measurement sensor can be implemented by, for example, a sensor device that performs object detection and measurement of a distance with a captured image or ultrasound or a sensor device such as LiDAR (Light Detection and ranging) that performs object detection with a laser beam.

The customer service robot 10 may include, as the sensor unit 158, a vibration detection sensor capable of detecting contact and a shock on the main body unit 11. The customer service robot 10 may include a GPS (Global Positioning System) sensor as the sensor unit 158 or a positioning unit 159 (see FIG. 4). The GPS sensor detects, for example, a presence position of the customer service robot 10 in the commercial facility. The customer service robot 10 may include, as the sensor unit 158, a speed sensor that detects moving speed of the customer service robot 10 and a steering angle sensor and a gyro sensor that detect a moving direction of the customer service robot 10.

Note that the configuration of the customer service robot 10 is not limited to the illustrated example. For example, the customer service robot 10 includes a battery (not illustrated) that supplies driving power of the customer service robot 10 itself to the main body unit 11 and the moving unit 12. The interface unit 13 may include a reader device that reads information from a card medium such as an IC card or a credit card. The customer service robot 10 may include a cash automatic adjustment machine and a printer.

### (Hardware Configuration of the Customer Service Robot)

A hardware configuration of the customer service robot 10 is explained with reference to FIG. 4. FIG. 4 is a diagram illustrating an example of a hardware configuration of the customer service robot according to the embodiment.

As illustrated in FIG. 4, the customer service robot 10 includes a CPU (Central Processing Unit) 151, a ROM (Read Only Memory) 152, and a RAM (Random Access Memory) 153.

The CUP 151 is an example of a processor and collectively controls the units of the customer service robot 10. The ROM 152 stores various programs. The RAM 153 is a work space in which programs and various data are loaded.

The CPU 151, the ROM 152, and the RAM 153 are connected via a bus and configures a control unit 154 having a computer configuration. In the control unit 154, the CPU 151 operates according to a program stored in the ROM 152 or a storage unit 161 and loaded in the RAM 153 to thereby execute various kinds of processing.

The customer service robot 10 includes the driving unit 121, the light emitting unit 141, the imaging unit 143 including the front imaging unit 1431 and the rear imaging unit 1432, the sound collecting unit 144 including the front sound collecting unit 1441 and the rear sound collecting unit 1442, and the voice output unit 145 explained above. The sound collecting unit 144 collects voice, for example, utterance of the customer around the customer service robot 10 and outputs a voice signal of the collected voice to the CPU 151. The voice output unit 145 outputs the voice under control of the CPU 151.

The customer service robot 10 includes a display unit 155, an operation unit 156, a reader writer unit 157, a sensor unit 158, a positioning unit 159, a communication unit 160, and the storage unit 161.

The display unit 155 is a display device such as the rear display unit 115 and the front display unit 132 explained above. The display unit 155 is configured by an LCD (Liquid Crystal Display) or the like. The display unit 155 displays various kinds of image information under the control of the CPU 151.

The operation unit 156 is an input device such as touch panels provided in the rear display unit 115 and the front display unit 132 and the stop button 142. The operation unit 156 outputs, to the CPU 151, operation content input via the input device. Note that the operation unit 156 may output voice (for example, utterance of the customer) input via the sound collecting unit 144 to the CPU 151 as operation content.

The reader writer unit 157 is a reader writer device capable of performing writing in and reading from a wireless tag. The reader writer unit 157 includes an antenna (not illustrated) for irradiating a radio wave and transmits writing target data via the antenna to write the data in the wireless tag. The reader writer unit 157 acquires, via the antenna, a radio wave emitted by the wireless tag to read data from the wireless tag.

The sensor unit 158 is various sensor devices such as the distance measurement sensor and the GPS sensor explained above. The sensor unit 158 outputs a sensing result obtained by sensing to the CPU 151.

The positioning unit 159 measures a present position of the customer service robot 10. The positioning unit 159 can be implemented by, for example, a positioning technique using a GPS sensor. The positioning unit 159 may be implemented by a position measuring device that makes use of a positioning technique such as beacon positioning. In this case, by providing terminals adapted to the positioning technique such as the beacon positioning in positions of the commercial facility, a present position of the customer service robot 10 can be measured (specified) by the positioning system formed by the terminals and the positioning unit 159.

The communication unit 160 is a wireless communication interface connectable to the network N. The communication unit 160 performs communication with external devices such as the server device 30 and the store device 20 via the network N. The communication unit 160 includes a short-range wireless communication function such as Bluetooth (registered trademark). For example, the communication unit 160 performs short-range wireless communication with the customer terminal 50 present around the customer service robot 10.

The storing unit 161 includes a storage medium such as a HDD (Hard Disk Drive) or a flash memory and maintains stored content even if a power supply is interrupted. The storage unit 161 stores programs executable by the CPU 151 and various kinds of setting information.

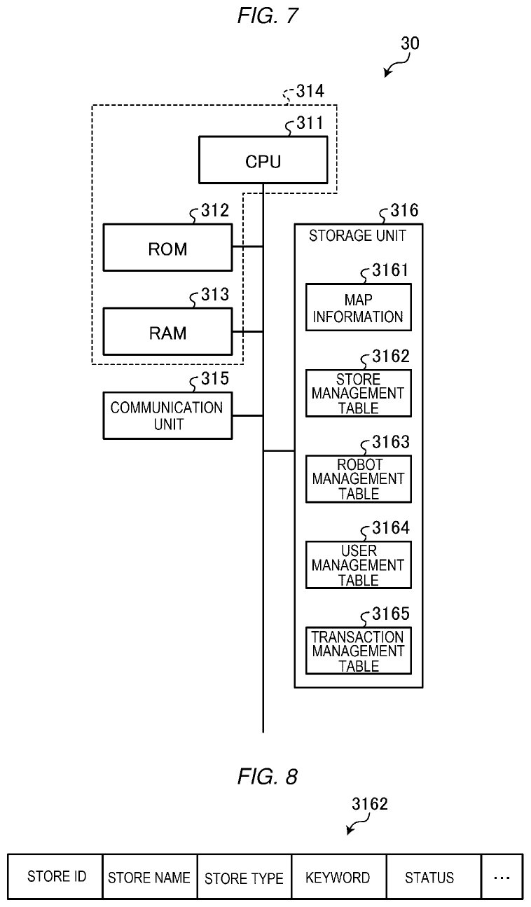

Information stored by the storing unit 161 is not limited to the illustrated example. For example, the storage unit 161 may store map information 3161 explained below (see FIG. 7), a facility information table, a commodity master 2191 of stores, and the like.

### (Hardware Configuration of the Store Device)

A hardware configuration of the store device 20 is explained with reference to FIG. 5. FIG. 5 is a diagram illustrating an example of a hardware configuration of the store device according to the embodiment.

Subsequently, the hardware configuration of the store device 20 is explained. FIG. 5 is a diagram illustrating an example of the hardware configuration of the store device 20. As illustrated in FIG. 5, the store device 20 includes a CPU 211, a ROM 212, and a RAM 213.

The CPU 211 is an example of a processor and collectively controls the units of the store device 20. The ROM 212 stores various programs. The RAM 213 is a work space in which programs and various data are loaded.

The CPU 211, the ROM 212, and the RAM 213 are connected via a bus or the like and configures a control unit 214 having a computer configuration. In the control unit 214, the CPU 211 operates according to a program stored in the ROM 212 or a storage unit 219 and loaded in the RAM 213 to thereby execute various kinds of processing.

The store device 20 includes a display unit 215, an operation unit 216, a communication unit 217, a connecting unit 218, and the storage unit 219.

The display unit 215 includes a display device such as an LCD. The display unit 215 displays various kinds of information under control of the CPU 211. The operation unit 216 includes an input device such as a keyboard or a pointing device. The operation unit 216 outputs operation content input via the input device to the CPU 211. Note that the operation unit 216 may be a touch panel provided on the display unit 215.

The communication unit 217 is a wireless communication interface connectable to the network N. The communication unit 217 performs communication with external devices such as the customer service robot 10 and the server device 30. The communication unit 217 may have a short-range wireless communication function and may perform communication with the customer service robot 10 by short-range wireless communication.

The connecting unit 218 is an interface for connecting various devices provided in a store. For example, a reader device capable of reading a code symbol, a printer device, and the like are connected to the connecting unit 218. Electronic shelf labels or the like installed in positions of display shelves of the store may be connected to the connecting unit 218. If the electronic shelf labels are connected, the control unit 214 performs control for causing the electronic shelf label displayed in a display position of a commodity to display a commodity name, a price, and the like of the commodity. If a light emitting element such as an LED is provided in the electronic shelf label, the control unit 214 performs, based on an instruction from the operation unit 216 or the external device such as the customer service robot 10, control for, for example, causing the light emitting element provided in the electronic shelf label to emit light.

The storage unit 219 includes a storage medium such as a HDD (Hard Disk Drive) or a flash memory and maintains stored contents even if a power supply is interrupted. The storage unit 219 stores programs executable by the CPU 211 and various kinds of setting information.

The storage unit 219 stores a commodity master 2191 in which information concerning commodities sold in the store is registered. The commodity master 2191 is a data table for storing and managing the information concerning the commodities sold in the store.

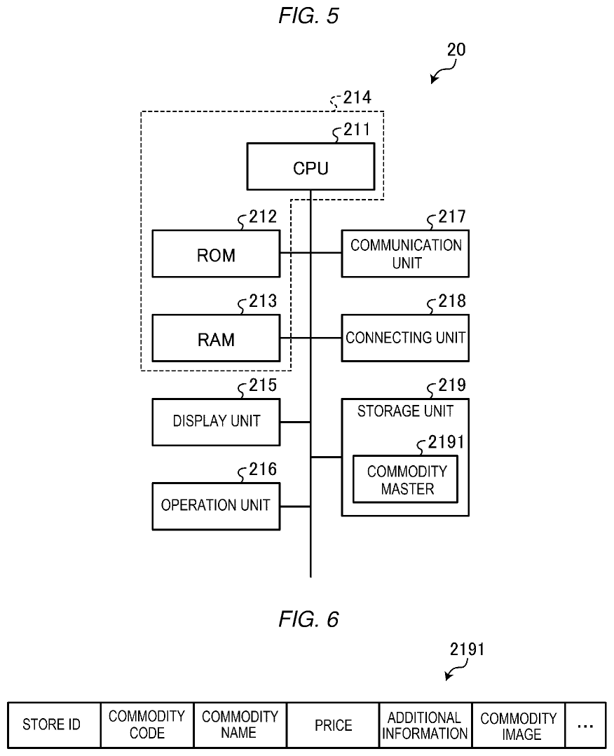

FIG. 6 is a diagram illustrating an example of a data configuration of the commodity master 2191. As illustrated in FIG. 6, the commodity master 2191 stores commodity information such as a commodity name, a price, additional information, and a commodity image in correlation with a store ID of the store and commodity codes of commodities sold in the store. The store ID is an example of an identifier capable of identifying each of the stores. The commodity code is an example of an identifier capable of identifying a type of a commodity.

A name of the commodity corresponding to the commodity code is stored in an item of the commodity name. A price of the commodity corresponding to the commodity code is stored in an item of the price. Additional information concerning the commodity corresponding to the commodity code is stored in an item of the additional information. For example, a type and the like of the commodity are stored in the item of the additional information. If the commodity is clothing, a size, a color, a design, a material, a brand, and the like are stored in the item of the additional information. Image data representing the commodity corresponding to the commodity code is stored in an item of the commodity image.

Note that the data configuration of the commodity master 2191 is not limited to the example illustrated in FIG. 6. For example, the commodity master 2191 may store the weight of the commodity in correlation with the commodity code. The commodity master 2191 may store, in correlation with the commodity code, information capable of specifying display positions of the commodity in the stores and electronic shelf labels disposed in the display positions.

Commodities registered in the commodity master 2191 are not limited to commodities that can be actually received and carried back from a store (hereinafter referred to as store commodities as well). For example, the commodities registered in the commodity master 2191 may be services.

For example, in a showroom type store that performs only exhibition of commodities, in some case, a commodity code of an exhibited commodity is read, the commodity is registered and settled, and the commodity is handed by a receiving method (delivery or reception at a reception counter or the like) designated by a customer. In such a case, information indicating whether the commodity corresponding to the commodity code is a store commodity explained above that can be received in the store or a provisional commodity explained below that cannot be received in the store may be stored as the additional information. For example, if settlement of the exhibited commodity is not performed in the store but is performed in an EC site operated by the store, an address and the like of the EC site may be stored as the additional information. That is, the exhibited commodity is a commodity, a real product of which cannot be received in the store. In the following explanation, the exhibited commodity is referred to as provisional commodity as well. A commodity that is a store commodity but is out of stock is also the provisional commodity.

### (Hardware Configuration of the Server Device)

A hardware configuration of the server device 30 is explained with reference to FIG. 7. FIG. 7 is a diagram illustrating an example of a hardware configuration of the server device according to the embodiment.

As illustrated in FIG. 7, the server device 30 includes a CPU 311, a ROM 312, and a RAM 313.

The CPU 311 is an example of a processor and collectively controls the units of the server device 30. The ROM 312 stores various programs. The RAM 313 is a work space in which programs and various data are loaded.

The CPU 311, the ROM 312, and the RAM 313 are connected via a bus and configures a control unit 314 having a computer configuration. In the control unit 314, the CPU 311 operates according to a control program stored in the storage unit 316 and loaded in the RAM 313 to thereby execute various kinds of processing.

The server device 30 includes a communication unit 315 and a storage unit 316. The communication unit 315 is a wired or wireless communication interface connectable to the network N. The communication unit 315 performs communication with external devices such as the customer service robot 10, the store device 20, and the parking lot system 40 via the network N.

The storage unit 316 includes a storage medium such as a HDD or a flash memory and maintains stored content even if a power supply is interrupted. The storage unit 316 stores programs executable by the CPU 311 and various kinds of setting information.

The storage unit 316 stores map information 3161, a store management table 3162, a robot management table 3163, a user management table 3164, and a transaction management table 3165.

The map information 3161 is information indicating a map of the commercial facility. In the map information 3161, positions of the stores present in the commercial facility and store IDs capable of identifying the stores in correlation with the positions of the stores are stored. For example, if the commercial facility has multilayer story structure, the map information 3161 is prepared for each of floors. In the map information 3161, positions of common spaces (for example, elevators, escalators, rest rooms, and resting places) other than the stores are also stored in correlation with identifiers. Information concerning the stores and the common spaces is described in, for example, a polygon format indicating shapes of those facilities and stored in the map information 3161. Further, in the map information 3161, information concerning passages inside the commercial facility is stored as link data such as point rows and surface rows configuring the passages.

The store management table 3162 is a data table for storing and managing information concerning the stores present in the commercial facility. FIG. 8 is a diagram illustrating an example of a data configuration of the store management table 3162. As illustrated in FIG. 8, the store management table 3162 stores store information such as a store name, a store type, a keyword, and a status in correlation with store IDs of the stores present in the commercial facility. Information indicating names of the stores corresponding to the store IDs is stored in an item of the store name.

For example, information indicating business types of the stores and classifications of commodities sold in the stores is stored in an item of the store type. For example, in the item of the store type, large classifications such as a restaurant and a retail store, middle classifications indicating classifications of commodities to be sold (for example, Japanese foods, Chinese foods, a clothing store, and an electrical appliance store), more detailed small classifications (sushi, soba, men's clothes, women's clothes, and the like), and the like can also be defined stepwise.

One or a plurality of keywords indicating features and characteristics of the stores are stored in an item of the keyword. The keywords can be optionally set for each of the stores. However, keywords classified by indicators based on store visiting actions of customers are preferably used. A keyword classified based on a common indicator is preferably used for stores in the same business type and the same genre.

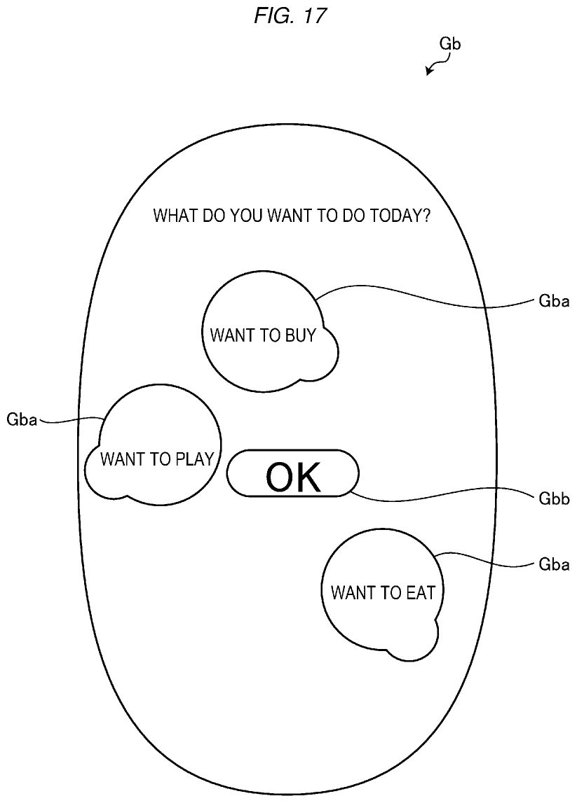

As an example, a keyword such as “want to eat” can be set in a restaurant, a keyword such as “want to buy” can be set in a retail store such as a clothing store, and a keyword such as “want to play” can be set in a store such as a game center. Keywords such as “for men”, “for women”, and “for families” may be set based on characteristics of commodities sold by the stores. Note that the keywords can be keywords in searching for a purpose of a customer on a store visiting purpose check screen Gb explained below (see FIG. 17). Therefore, it is preferable to set a name based on a store visiting action of the customer.

Information indicating states such as congestion situations of the stores and store opening and closing is stored in an item of the status. By using the information stored in the status, for example, if an action plan of a customer explained below is set, it is possible to guide the customer to a store as unoccupied as possible. It is possible to avoid guidance to a closed store.

Note that the data configuration of the store management table 3162 is not limited to the example illustrated in FIG. 8. For example, the store management table 3162 may store, in correlation with a store ID, position information indicating a position of a store corresponding to the store ID. Further, the store management table 3162 may store information concerning a common space other than the stores.

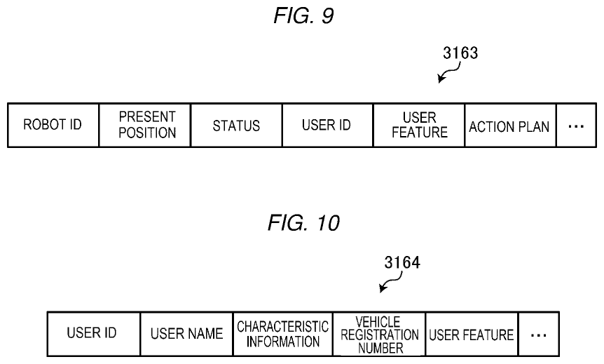

The robot management table 3163 is a data table for storing and managing information concerning the customer service robot 10. FIG. 9 is a diagram illustrating an example of a data configuration of the robot management table 3163. As illustrated in FIG. 9, the robot management table 3163 stores robot information such as a present position, a status, a user ID, a user feature, an action plan in correlation with a robot ID. The robot ID is an identifier capable of identifying each of the customer service robots 10.

Information indicating a present position of the customer service robot 10 is stored in an item of the present position. Information indicating a present state of the customer service robot 10 corresponding to the robot ID is stored in an item of the status. For example, information indicating a present operation mode of the customer service robot 10 is stored. For example, information indicating the remaining power of a battery loaded on the customer service robot 10 is stored.

A user ID of a customer being attended by the customer service robot 10, that is, a customer who checked in to the customer service robot 10 (hereinafter referred to as check-in user as well) is stored in an item of the user ID. Note that, as explained below, the customer service robot 10 is capable of operating even if the item of the user ID is empty.

Information indicating features in appearance of a customer who is checking in to the customer service robot 10 is stored in an item of the user feature. For example, a front image and a rear image obtained by imaging a face or a figure of the customer (hereinafter referred to as customer image as well) and a feature value indicating a feature of the face or the figure of the customer are stored in the item of the user feature. The user feature is used if the customer who is checking in is recognized from an image captured by the imaging unit 143. The user feature is used to specify the position of the customer if the customer service robot 10 leads the customer and moves and if the customer service robot 10 moves following the customer. An action plan explained below generated by the customer service robot 10 is stored in an item of the action plan.

Note that the data configuration of the robot management table 3163 is not limited to the example illustrated in FIG. 9. For example, the robot management table 3163 may store, in correlation with the robot ID, as user setting, changed content of the customer service robot 10 changed by personalize processing explained below. The robot management table 3163 may store, in correlation with the robot ID, an image, a video, voice, and the like acquired by the customer service robot 10 corresponding to the robot ID together with an acquisition date and time.

The user management table 3164 is a data table for storing and managing information concerning a customer. FIG. 10 is a diagram illustrating an example of a data configuration of the user management table 3164. As illustrated in FIG. 10, the user management table 3164 stores user information such as a user name, characteristic information, a vehicle registration number, and user setting in correlation with a user ID. The user ID is an example of an identifier capable of identifying each of customers.

Information indicating a name of the customer is stored in an item of the user name. Information indicating characteristics of the customer corresponding to the user ID is stored in an item of the characteristic information. For example, the characteristic information includes information indicating sex, age, a taste, and the like of the customer. The information indicating the taste may be information set by the customer himself or herself or may be information derived from a purchase history, a search history, and the like of the customer. In the latter case, for example, the control unit 314 may be configured to extract a purchase history of the customer corresponding to the user ID from the transaction management table 3165 or the like explained below and estimate a taste of the customer based on the extracted purchase history. For example, the control unit 314 may acquire a purchase history and a search history correlated with the user ID from an external system and estimate a taste of the customer based on acquired information. Note that a method of estimating a taste does not particularly matter. A publicly-known technique can be used.

A vehicle registration number of a vehicle owned by the customer is stored in an item of the vehicle registration number. The vehicle registration number is used to acquire entering time of the relevant vehicle from the parking lot system 40. The customer service support system 1 informs, for example, based on the entering time of the vehicle of the customer, a parking time and a parking fee to the customer being attended. The vehicle registration number is used to acquire a parking position of the relevant vehicle from the parking lot system 40. The customer service support system 1 transports a commodity purchased by the customer to the parking position, for example, according to an instruction of the customer.

The same content as the user information stored in the robot management table 3163 explained above is stored in an item of the user feature.

Note that the data configuration of the user management table 3164 is not limited to the example illustrated in FIG. 10. For example, the user management table 3164 may include, in correlation with the user ID, a terminal ID, address information, and the like of a terminal (the customer terminal 50) used by the customer. In order to perform face authentication for the customer, the user management table 3164 may store, in correlation with the user ID, a face image obtained by imaging the face of the customer and a feature value indicating a feature of the face.

The user management table 3164 may store, in correlation with the user ID, information capable of specifying a delivery destination of a commodity such as an address of the customer. The user management table 3164 may store settlement information in correlation with the user ID. The settlement information is information such as an account for using an electronic settlement service for which the customer has a contract in advance. The electronic settlement service includes code settlement, electronic money settlement, and credit settlement. If the electronic settlement service is the credit settlement, the settlement information may be a number of a credit card owned by the customer.

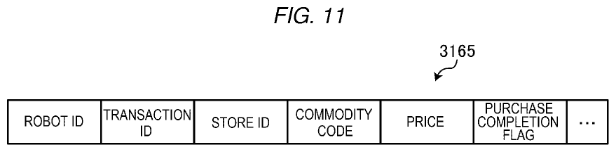

The transaction management table 3165 is a data table for storing and managing information concerning a transaction performed via the customer service robot 10. FIG. 11 is a diagram illustrating an example of a data configuration of the transaction management table 3165. As illustrated in FIG. 11, the transaction management table 3165 stores transaction information such as a store ID, a commodity code, a price, and a purchase completion flag in correlation with a robot ID and a transaction ID.

The transaction ID is an identifier capable of identifying each of transactions performed by the customer service robot 10 corresponding to the robot ID. As the transaction ID, a specific transaction ID is issued by the customer service robot 10 every time check-in of a customer is performed and the same transaction ID is continuously used until checkout operation for instructing a use end of the customer service robot 10 (or a customer service end by the customer service robot 10) is performed by the customer.

Note that, in this embodiment, each of the customer service robots 10 issues a transaction ID. However, not only this, but the server device 30 may issue a transaction ID. In this case, the control unit 314 of the server device 30 monitors statuses of the customer service robots 10 based on the robot management table 3163 and, if detecting the customer service robot 10, the status of which was switched to the customer service mode, issues a transaction ID to the customer service robot 10. By notifying the issued transaction ID to the customer service robot 10 corresponding to the transaction ID, the control unit 314 of the server device 30 can cause the customer service robot 10 to use the same transaction ID while the customer service mode of the customer service robot 10 continues.

A store ID, a commodity code, and a price relating to a commodity registered using the customer service robot 10 corresponding to the robot ID are registered in items of the store ID, the commodity code, and the price. Information indicating whether settlement (checkout) for the commodity corresponding to the commodity code was completed is stored in an item of the purchase completion flag.

Note that the data configuration of the transaction management table 3165 is not limited to the example illustrated in FIG. 11. For example, the transaction management table 3165 may store, in correlation with the robot ID, a user ID of a check-in user who checked in to the customer service robot 10 corresponding to the robot ID. The transaction management table 3165 may store, in correlation with the commodity code, information indicating whether the commodity corresponding to the commodity code is a store commodity or a provisional commodity. The transaction management table 3165 may store, in correlation with the commodity code, a date and time when registration or settlement of the commodity corresponding to the commodity code was performed.

It is assumed that the transaction management table 3165 is updated every time registration or settlement is performed in each of the customer service robots 10. Note that, in data stored in the transaction management table 3165, according to an instruction of a customer service end or the like designating a transaction ID notified from the customer service robot 10, data of the robot ID corresponding to the transaction ID and the transaction ID may be cleared or may be continuously retained. In the latter case, the data stored in the transaction management table 3165 can be treated as purchase histories of customers who used the commercial facility.

The data table stored by the server device 30 is not limited to the example explained above. For example, the server device 30 may store a commodity master of all the stores in the commercial facility in the storage unit 316 or the like as a comprehensive commodity master.

### (Functional Configuration of the Customer Service Support System)

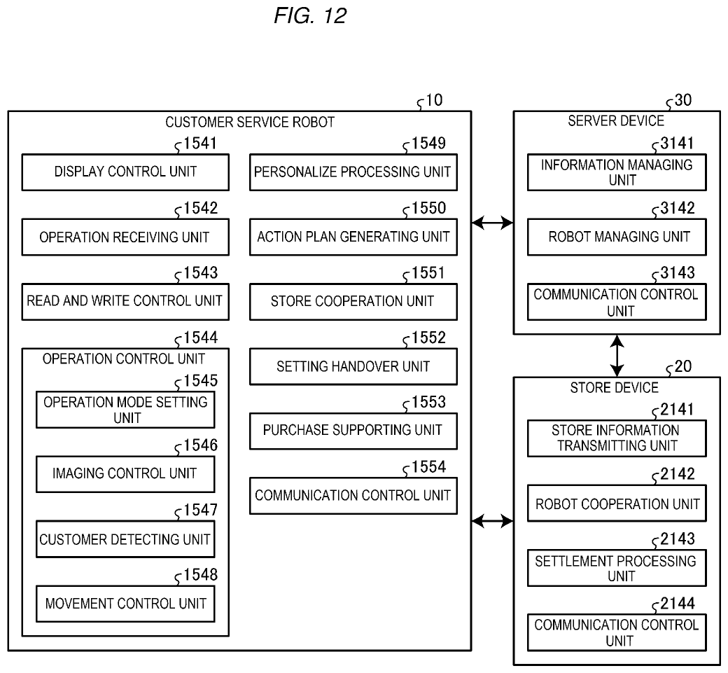

Subsequently, functional configurations of the customer service robot 10, the store device 20, and the server device 30 explained above are explained. FIG. 12 is a functional block diagram illustrating an example of functional configurations of the customer service robot, the store device, and the server device. First, the server device 30 is explained.

### (Functional Configuration of the Server Device)

The CPU 311 operates according to a program stored in the ROM 312 or the storage unit 316, whereby the control unit 314 of the server device 30 functions as an information managing unit 3141, a robot managing unit 3142, and a communication control unit 3143. Note that a part or all of the functions may be implemented by hardware such as dedicated circuits.

The information managing unit 3141 cooperates with each of the customer service robot 10, the store device 20, and the parking lot system 40 to update the various data tables stored in the storage unit 316. For example, the information managing unit 3141 acquires information relating to the various data tables from each of the customer service robot 10, the store device 20, and the parking lot system 40 and updates the various data tables based on the acquired information.

A method of acquiring the information does not particularly matter. Various methods can be used as the method. For example, the information managing unit 3141 may acquire the information with a push type for passively acquiring the information transmitted from each of the customer service robot 10, the store device 20, and the parking lot system 40. The information managing unit 3141 may acquire the information with a pull type for actively acquiring the information by, for example, requesting each of the customer service robot 10, the store device 20, and the parking lot system 40 to provide information.

For example, if acquiring information concerning a status from the store device 20, the information managing unit 3141 updates the status relating to the store ID of the store device 20 stored in the store management table 3162.

For example, if acquiring information concerning position information, a status, and an action plan from the customer service robot 10, the information managing unit 3141 updates relevant data entry in the robot management table 3163 stored in correlation with the robot ID of the customer service robot 10. If acquiring a user ID and user setting of a customer being attended from the customer service robot 10, the information managing unit 3141 updates relevant data entry in the user management table 3164 stored in correlation with the user ID. For example, if acquiring information concerning a transaction from the customer service robot 10 together with a transaction ID, the information managing unit 3141 performs addition or deletion of a data entry, update of a purchase complete flag, and the like on the transaction management table 3165 based on the robot ID of the customer service robot 10 and the transaction ID.

Note that, in this embodiment, it is assumed that static information such as the user ID, the user name, the characteristic information, and the vehicle registration number among the user information stored in the user management table 3164 is registered in advance. However, not only this, but, for example, registration (hereinafter referred to as member registration as well) of a new user of the customer service support system 1 may be performed via the customer service robot 10 and the customer terminal 50. In this case, the user management table 3164 adds user information of the new user acquired from the customer service robot 10 or the customer terminal 50 to the user management table 3164.

The information managing unit 3141 provides the map information 3161 and the various data tables stored in the storage unit 316 to be referrable from each of the customer service robot 10 and the store device 20. A method of providing data does not particularly matter. For example, the information managing unit 3141 provides the map information 3161 and the various data tables with a technique such as file sharing to be referrable from each of the customer service robots 10. For example, the information managing unit 3141 extracts relevant data entry from the various data tables and provides the data entry to the customer service robot 10 at a request source according to a query including a robot ID, a user ID, a store ID, and the like as keys.

The robot managing unit 3142 collectively manages an operation of the customer service robot 10 in the commercial facility based on position information, a status, and the like of the customer service robot 10. For example, if the customer service robot 10 in a standby state (a standby mode) that does not perform a customer service is present, the robot managing unit 3142 instructs the customer service robot 10 in the standby state to move to a moving destination or the like. As an example, the robot managing unit 3142 instructs, based on positions of the customer service robots 10, the customer service robot 10 in the standby state to move to an entrance of the commercial facility, an area where a relatively small number of customer service robots 10 are present, or the like.

The communication control unit 3143 controls various kinds of communication between the server device 30 and the customer service robot 10. The communication control unit 3143 controls various kinds of communication between the server device 30 and the store device 20.

### (Functional Configuration of the Store Device)

The CPU 211 operates according to a program stored in the ROM 212 or the storage unit 219, whereby the control unit 214 of the store device 20 functions as a store information transmitting unit 2141, a robot cooperation unit 2142, a settlement processing unit 2143, and a communication control unit 2144. Note that a part or all of the functions may be implemented by hardware such as dedicated circuits.

The store information transmitting unit 2141 transmits, to the server device 30, store information concerning the store. For example, the store information transmitting unit 2141 transmits information indicating a congestion state of the store and a state of store opening and closing and the like to the server device 30 together with the store ID of the store. The congestion state of the store may be derived based on, for example, the number of customers visiting the store (customer service robots 10) per unit time. The congestion state of the store may be derived based on, for example, the number of customers included in images captured by monitoring cameras provided in the store. The store information transmitting unit 2141 may transmit a keyword relating to the store input by a store clerk or the like to the server device 30 together with the store ID of the store. The store information transmitting unit 2141 may transmit the commodity master 2191 of the store to the server device 30.

The robot cooperation unit 2142 establishes communication with the customer service robot 10 at an access source to implement cooperation with the customer service robot 10. The robot cooperation unit 2142 provides the commodity master 2191 stored by the store device 20 to the cooperating customer service robot 10 to be referrable by the customer service robot 10.

The robot cooperation unit 2142 cooperates with the customer service robot 10 to control light emission of electronic shelf labels provided in the store. For example, if receiving a light emission instruction designating a type of a commodity or the commodity from the customer service robot 10, the robot cooperation unit 2142 causes an electronic shelf label in a display position of the commodity of the type or the commodity designated by the light emission instruction to emit light.

The settlement processing unit 2143 executes settlement processing for a commodity sold in the store. For example, the settlement processing unit 2143 executes processing for calculating a total amount based on commodity codes and the numbers of items of commodities registered by a registration device provided in the store or the customer service robot 10 and settling the total amount with a payment amount of the customer. If the settlement processing was completed, the settlement processing unit 2143 causes a not-illustrated printer to dispense a receipt on which details of the settlement processing are printed.

The communication control unit 2144 controls various kinds of communication between the store device 20 and the customer service robot 10 via the network N, short-range wireless communication, or the like. The communication control unit 2144 controls various kinds of communication between the store device 20 and the server device 30.

### (Functional Configuration of the Customer Service Robot)

The CPU 151 operates according to a program stored in the ROM 152 or the storage unit 161, whereby the control unit 154 of the customer service robot 10 functions as a display control unit 1541, an operation receiving unit 1542, a read and write control unit 1543, an operation control unit 1544, a personalize processing unit 1549, an action plan generating unit 1550, a store cooperation unit 1551, a setting handover unit 1552, a purchase supporting unit 1553, and a communication control unit 1554. Note that a part or all of the functions may be implemented by hardware such as dedicated circuits.

The display control unit 1541 causes the display unit 155 to display various kinds of information. Specifically, the display control unit 1541 cooperates with the functions of the customer service robot 10 to cause the rear display unit 115 and the front display unit 132 to display various screens (GUIs: Graphical User Interfaces). Screen examples displayed by the display control unit 1541 are explained below.

The operation receiving unit 1542 receives user operation via the operation unit 156. For example, the operation receiving unit 1542 receives operation for the rear display unit 115 and the front display unit 132. The operation receiving unit 1542 receives operation for the stop button 142. The operation receiving unit 1542 receives utterance of a customer via the sound collecting unit 144 such as a wake word. The operation receiving unit 1542 receives an operation instruction by the customer terminal 50 and an operation instruction by a remote controller device.

The read and write control unit 1543 reads information via the imaging unit 143, the reader writer unit 157, and the like. For example, if a code symbol such as a barcode or a two-dimensional code is imaged by the imaging unit 143, the read and write control unit 1543 decodes the code symbol to read information (for example, a commodity code) stored in the code symbol. For example, the read and write control unit 1543 controls the reader writer unit 157 to read information (for example, a commodity code) stored in a wireless tag attached to a commodity or the like. For example, the read and write control unit 1543 controls the reader writer unit 157 to write information in the wireless tag.

For example, the read and write control unit 1543 reads a user ID from a code symbol displayed on the customer terminal 50. For example, the read and write control unit 1543 reads a commodity code from a code symbol attached to a commodity. The read and write control unit 1543 reads a commodity code from a wireless tag attached to a commodity.

The operation control unit 1544 collectively controls an operation of the customer service robot 10. The operation control unit 1544 further includes an operation mode setting unit 1545, an imaging control unit 1546, a customer detecting unit 1547, and a movement control unit 1548.

The operation control unit 1544 instructs the front imaging unit 1431 to capture a customer image if the customer checks in. At this time, a front image and a rear image of the customer are captured. Note that, in capturing a customer image (the front image and the rear image), it is desirable that the customer service robot 10 captures the customer image while turning around the customer to prevent the customer from wasting time. The operation control unit 1544 extracts user features out of the captured image and causes the user management table 3164 stored by the server device 30 to store the user features.

The operation mode setting unit 1545 included in the operation control unit 1544 sets an operation mode of the customer service robot 10. The customer service robot 10 roughly includes three operation modes of a standby mode, a customer service mode, and an after-store closing mode. The customer service robot 10 includes, as moving forms of the customer service robot 10 in the customer service mode, a leading mode for leading the customer and moving and a following mode for moving following the customer. The operation mode setting unit 1545 sets the operation mode of the customer service robot 10 to any one of the standby mode, the customer service mode, and the after-store closing mode. The operation mode setting unit 1545 sets a moving form at the customer service mode time to the leading mode or the following mode. The operation mode setting unit 1545 is an example of the moving form setting unit in the present disclosure. Note that the leading mode and the following mode are explained in detail below.

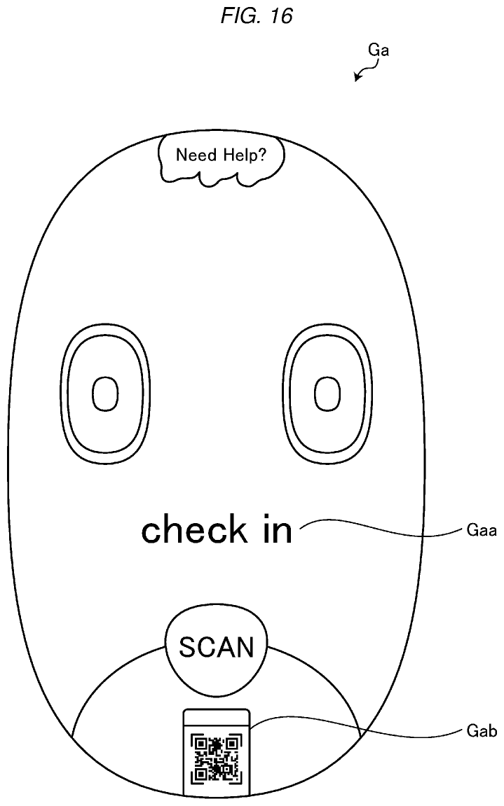

The standby mode is an operation mode at the time of a standby state in which a customer service is not performed. In the standby mode, the operation control unit 1544 causes the front display unit 132 to display a check-in screen for starting use of the customer service robot 10. For example, in the standby mode, the operation control unit 1544 causes the front display unit 132 to display a check-in screen Ga (see FIG. 16). Details of the check-in screen Ga are explained below.

Note that, during the standby mode, the operation control unit 1544 may cause the rear display unit 115 to display a message for informing that check-in is possible, an advertisement screen of the commercial facility, and the like. The operation control unit 1544 may cause the voice output unit 145 to output voice for urging check-in operation.

During the standby mode, the operation control unit 1544 may cause the customer service robot 10 to stop in a predetermined position, cause the customer service robot 10 to travel on a predetermined route, or may cause the customer service robot 10 to travel according to an instruction from the server device 30. Note that it is assumed that, if causing the customer service robot 10 to travel at the time of the standby mode, the operation control unit 1544 causes the customer service robot 10 to stop on condition that the operation control unit 1544 detected, via the sensor unit 158 or the sound collecting unit 144, presence of a customer around the customer service robot 10 or voice for calling to stop by the customer.

If the customer has meal while touring stores, the operation control unit 1544 causes the customer service robot 10 to shift to the standby mode. At this time, for example, the operation control unit 1544 may close a lockable door member provided in an upper part of the placing table 112 and protect commodities and luggage placed on the placing table 112 during the standby mode.

If completing the movement to all the stores specified in the action plan, the operation control unit 1544 ends the action support for the customer based on the action plan according to, for example, check-out operation instructed from the customer. If ending the action support, the operation control unit 1544 clears various data such as the user ID, the user setting, the action plan, and the local transaction management table stored in the customer service robot 10 and causes the customer service robot 10 to shift to the standby move. Note that the check-out operation may be performed at any timing without being limited to be performed at the completion time of the movement to all the stores specified in the action plan.

The customer service robot 10, which shifted to the standby mode, moves to a predetermined position in the commercial facility according to control of the operation control unit 1544. As an example, after shifting to the standby mode, the customer service robot 10 moves to a charging area where the battery can be charged.

The customer service robot 10 in the standby mode may be configured to move to a designated position according to an instruction from the store device 20 or the server device 30. In this case, the number of movable customer service robots 10 is not limited to one. It is also possible to collectively move a plurality of customer service robots 10.

The customer service mode is an operation mode for performing customer service. In the customer service mode, the operation control unit 1544 enables the personalize processing unit 1549, the action plan generating unit 1550, the store cooperation unit 1551, the setting handover unit 1552, and the purchase supporting unit 1553 and performs action support for the customer.

In the customer service mode, the movement control unit 1548 included in the operation control unit 1544 controls the driving unit 121 and causes, based on an image captured by the imaging unit 143 and sensing results of the various sensor units 158, the customer service robot 10 to travel along a moving route (hereinafter referred to as touring route or touring order as well) generated by the action plan generating unit 1550 explained below to cause the customer service robot 10 to autonomously travel to guide the customer. In particular, in the customer service robot 10 in this embodiment, the movement control unit 1548 causes, in the moving form (the leading mode or the following mode) set by the operation mode setting unit 1545, the customer service robot 10 to move in a state in which the distance to the customer is kept constant.

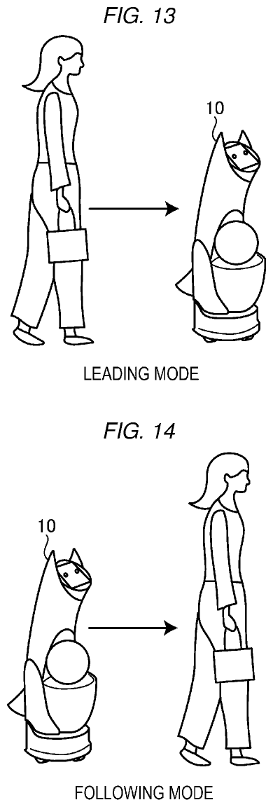

In the customer service mode, there are the leading mode and the following mode as moving forms in moving while being accompanied by the customer. The leading mode is a form of leading a customer and moving along a set moving route. Note that the leading mode is an example of the first moving form in the present disclosure. FIG. 13 is a diagram illustrating an example of a state in which the customer service robot is leading the customer in the leading mode. As illustrated in FIG. 13, the customer service robot 10 leads the customer and moves while keeping the distance to the customer constant. On the other hand, the following mode is a form of moving following the customer. Note that the following mode is an example of the second moving form in the present disclosure. FIG. 14 is a diagram illustrating an example of a state in which the customer service robot is following the customer in the following mode. As illustrated in FIG. 14, the customer service robot 10 moves following the customer while keeping the distance to the customer constant.

The movement control unit 1548 implements movement by the leading mode or the following mode with actions of the imaging control unit 1546 and the customer detecting unit 1547, both of which are included in the operation control unit 1544. Irrespective of the set moving form (the leading mode or the following mode), the movement control unit 1548 causes the customer service robot 10 to move in a state in which the distance to the customer is kept constant.

The imaging control unit 1546 causes the front imaging unit 1431 (the first imaging unit), which images the front side of the moving direction of the customer service robot 10, and the rear imaging unit 1432 (the second imaging unit), which images the rear side of the moving direction, to perform imaging.

If the operation mode setting unit 1545 set the leading mode (the first moving form), the customer detecting unit 1547 recognizes, out of an image captured by the rear imaging unit 1432 (the second imaging unit), the position of the customer based on a front image of the customer registered in advance. If the operation mode setting unit 1545 set the following mode (the second moving form), the customer detecting unit 1547 recognizes, out of an image captured by the front imaging unit 1431 (the first imaging unit), the position of the customer based on a rear image of the customer registered in advance. Note that the customer detecting unit 1547 is an example of the image processing unit in the present disclosure.

The movement control unit 1548 leads the customer or follows the customer in a state in which the distance between the customer recognized by the customer detecting unit 1547 and the customer service robot 10 is kept constant. Note that, if the customer service robot 10 and the customer terminal 50 are connected by short-range wireless communication, the customer service robot 10 can detect an approximate position of the customer terminal 50 based on RSSI (reception signal intensity). It is possible to narrow down the position of the customer by using the position of the customer terminal 50 detected in this way. The distance between the customer service robot 10 and the customer terminal 50 may be estimated and the customer service robot 10 may lead or follow the customer based on the estimated distance. Alternatively, the customer detecting unit 1547 can further improve efficiency of processing for detecting the customer by narrowing down a range in which the customer is detected out of an image captured by the front imaging unit 1431 or the rear imaging unit 1432 to a range corresponding to an estimation result of the distance and the direction between the customer service robot 10 and the customer terminal 50.

If the customer service robot 10 shifted to the leading mode, the movement control unit 1548 causes the customer service robot 10 to move to a destination store based on an action plan generated by the action plan generating unit 1550 explained below. Specifically, the movement control unit 1548 causes the customer service robot 10 to move in the order of destination stores specified in the action plan. The movement control unit 1548 causes the customer service robot 10 to travel at speed corresponding to a moving time between stores specified in the action plan.

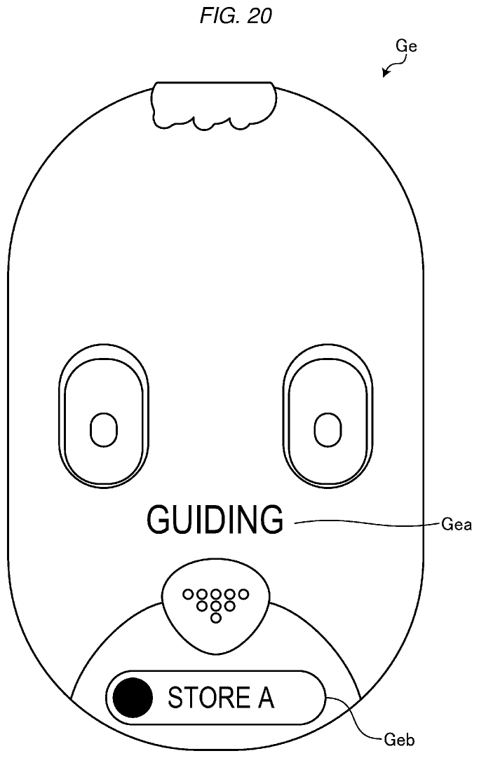

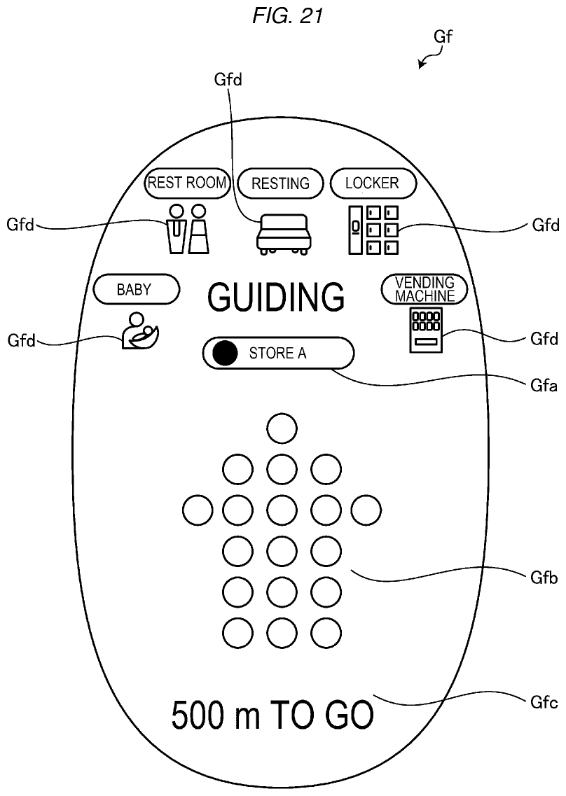

The operation control unit 1544 urges the customer to move following the customer service robot 10 by causing the rear display unit 115 to display a guidance screen Gf (see FIG. 21) for informing that the customer is guided to a destination store. Details of the guidance screen Gf are explained below. In the leading mode, the operation control unit 1544 calls attention of customers in the periphery by causing the front display unit 132 to display a notice screen Ge (see FIG. 20) indicating that the customer is led. Details of the notice screen Ge are explained below. Note that the functional units of the customer service robot 10 cooperate with the display control unit 1541 to thereby display various screens on the front display unit 132 or the rear display unit 115. Since explanation is complicated, in the following explanation, it is simply described that “a target functional unit causes a target display unit to display various screens and various kinds of information”.

The operation control unit 1544 may perform guidance by voice output without being limited to the guidance by the screen display. For example, the operation control unit 1544 may output voice for informing movement to a destination store from the voice output unit 145 simultaneously with displaying the guidance screen Gf.

The customer can easily check a destination store, a distance to the store, and the like by viewing the guidance screen Gf displayed on the rear display unit 115 of the leading customer service robot 10. Since the customer can easily check a common space present in the vicinity during the movement to the destination store, the customer can move to the common space according to necessity.

The operation control unit 1544 is capable of receiving operation of the customer even while the customer service robot 10 is operating in the leading mode. For example, if receiving operation of the stop button 142 during the movement of the customer service robot 10, the operation control unit 1544 causes the customer service robot 10 to stop the movement. For example, if receiving operation for touching the rear display unit 115, operation for knocking the main body unit 11, calling operation such as a wake word, or the like, the operation control unit 1544 causes the customer service robot 10 to stop the movement. For example, the operation control unit 1544 stops the traveling of the customer service robot 10 according to, for example, an instruction from the customer terminal 50 paired with the customer service robot 10 in advance. The operation control unit 1544 causes the rear display unit 115 to display a generated action plan screen Gd (see FIG. 16) or the like to enable various kinds of operation to be received. If receiving, from the customer, for example, an instruction to move to a common space if the customer service robot 10 is moving according to the set moving route, the operation control unit 1544 changes the action plan and leads the customer to the instructed common space. At that time, the action plan generating unit 1550 resets a moving route.

Note that, if stopping the traveling of the customer service robot 10, the operation control unit 1544 may stop the customer service robot 10 in a state in which the front display unit 132 is directed to the customer.

If the customer moved away from the customer service robot 10 by moving to the common space or a rest room while being led in the leading mode, the customer moves in a direction different from a moving direction of the customer service robot 10 and performs a motion outside the action plan in which the distance to the customer service robot 10 deviates from a specified value. If detecting the motion of the customer outside the action plan based on, for example, an image captured by the imaging unit 143, the mode setting unit 1545 releases the leading mode and causes the customer service robot 10 to shift to the following mode for moving following the customer. If the customer entered the common space or the rest room, the operation control unit 1544 stays on standby at an entrance of the common space or the rest room until the customer comes out from the common space or the rest room. If the customer matching the user features came out from the common space or the rest room, the mode setting unit 1545 causes the customer service robot 10 to shift to the leading mode and continues the guidance to the destination store. Note that the operation control unit 1544 causes the action plan generating unit 1550 explained below to reset a route for returning to the initial action plan from a position where the customer deviated from the action plan.

Similarly, if the customer moves to another store not registered in the action plan while being led, the operation mode setting unit 1545 releases the leading mode and causes the customer service robot 10 to shift to the following mode. In this case, the operation mode setting unit 1545 continues the following mode until the customer leaves the store and, if detecting, based on position information or the like output by the positioning unit 159, that the customer left the store, causes the customer service robot 10 to shift to the leading mode and continues the guidance to the destination store. Note that, in this case, the operation control unit 1544 may cooperate with the action plan generating unit 1550 and update the action plan, for example, change touring order of the destination store.

If, according to the movement by the leading mode, the present position of the customer service robot 10 enters an area of the destination store or an area in a predetermined range starting from the position of the destination store, the operation mode setting unit 1545 determines that the customer service robot 10 reached the destination store. If determining that the customer service robot 10 reached the destination store, the operation control unit 1544 shifts the operation mode of the customer service robot 10 from the leading mode to the following mode.

Note that it is assumed that the range of the area relating to the determination for reaching the destination store can be optionally set. For example, the entire site of the store may be set as the area relating to the reaching determination. For example, if a specific store (restaurant) present in a food court is the destination store, the entire region of the food court may be set as the area relating to the reaching determination.

If the customer service robot 10 shifted to the following mode, the movement control unit 1548 performs control for causing the customer service robot 10 to move following the check-in user (customer).

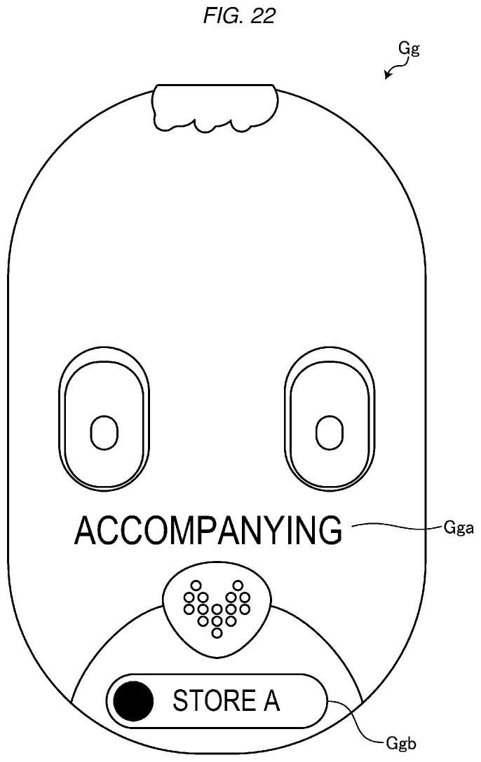

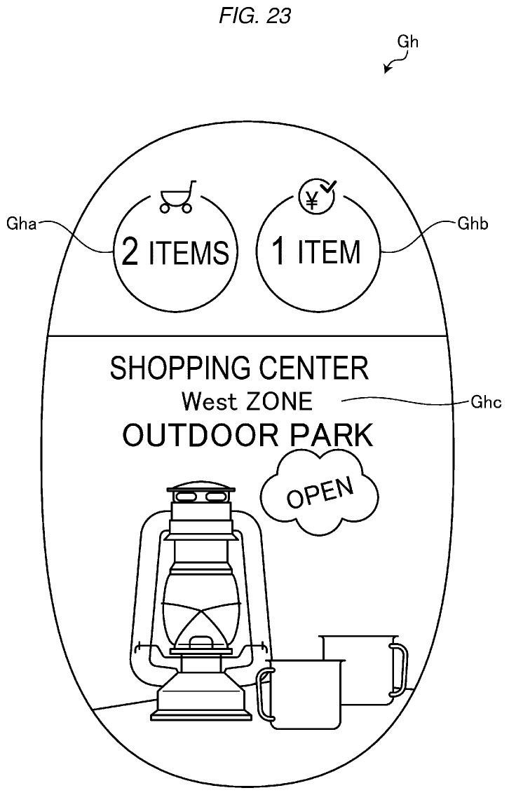

Note that, in the following mode, the operation control unit 1544 causes the front display unit 132 to display a notice screen Gg (see FIG. 22) indicating a following operation such as “I will accompany you”. Details of the notice screen Gg are explained below. In the following mode, the operation control unit 1544 causes the rear display unit 115 to display an information display screen Gh (see FIG. 23) including an advertisement relating to the commercial facility and a state of registration and settlement of a commodity of the customer being guided. Details of the information display screen Gh are explained below. The information display screen Gh may include information for informing that the customer service robot 10 is operating in the following mode and information such as publicity for urging use of the customer service robot 10.

Among the operation modes of the customer service robot 10, the after-store closing mode is an operation mode for performing a job other than the customer service, for example, after closing of the commercial facility.

If the present date and time reached the outside of the business hour of the commercial facility, the operation control unit 1544 causes the customer service robot 10 to shift to the after-store closing mode.

The customer service robot 10 in the after-store closing mode performs an operation different from the operations in the standby mode and the customer service mode explained above. For example, the operation control unit 1544 causes the customer service robot 10 to travel on a predetermined route in the commercial facility and images a peripheral environment using the imaging unit 143 to perform a patrol job for the commercial facility and the stores.

The customer service robot 10 in the after-store closing mode may support an inventory job in a preset store. In this case, for example, while the customer service robot 10 is touring in the store, the operation control unit 1544 causes the reader writer unit 157 to operate to read commodity codes and individual item codes from wireless tags of commodities present in the store. The operation control unit 1544 totalizes the numbers of items of the commodities based on a reading result and, for example, transmits an inventory result to the store device 20.

The personalize processing unit 1549 performs personalize processing for changing setting concerning the operation of the customer service robot 10 from an initial state according to operation of the check-in user. The personalize processing unit 1549 performs personalize processing for changing characteristic information of the user management table 3164 and setting stored in user setting.

It is assumed that changeable setting of the customer service robot 10 does not particularly matter if the changeable setting is within a range not hindering a basic operation of the customer service robot 10. For example, a light emission color of the light emitting unit 141, UI (for example, language setting corresponding to a mother tongue of a customer), voice (male voice or female voice) emitted by the customer service robot 10, and the like can be changed. For example, the light emission color of the light emitting unit 141 can be changed to a favorite color of the customer based on an attribute of the customer stored in the characteristic information of the user management table 3164 and taste information of the customer stored in the user setting. If the customer service robot 10 includes a voice assistant function, a wake word used in calling (starting) the voice assistant function can be changed. Various informing methods performed by the customer service robot 10, a settlement method, and the like can be set. Note that the setting of the initial state of the customer service robot 10 may be the same or may be different.

It is assumed that a method of changing setting does not particularly matter either and the setting can be changed by screen operation or voice operation. For example, after check-in operation, the personalize processing unit 1549 may cause the front display unit 132 to display a screen for checking whether to perform a setting change. In this case, if the setting change is instructed, the personalize processing unit 1549 causes the front display unit 132 to display a setting change screen showing changeable items (both of the screens are not illustrated). If setting content after the change was determined by operation of the customer, the personalize processing unit 1549 changes setting of the customer service robot 10 to the setting content after the change. Note that it is assumed that the setting change can be performed at any timing during the customer service mode.

If the setting change was performed, the personalize processing unit 1549 registers the setting content after the change in the user management table 3164 as user setting in correlation with a user ID of the check-in user.

Note that, if the check-in user is a member of the customer service support system 1, the personalize processing unit 1549 may read the user setting stored in correlation with the user ID of the check-in user from the user management table 3164 and change the setting of the customer service robot 10 based on the user setting. If user setting is included in a code symbol displayed on the customer terminal 50, personalize processing unit 1549 may change the setting of the customer service robot 10 based on the user setting read by the read and write control unit 1543 at the time of the check-in.

As explained above, the customer service robot 10 changes the setting according to the operation of the customer to allow customization for each of customers. Consequently, the customer can easily identify the customer service robot 10 that attends the customer and the other customer service robots 10. The customer can perform shopping and the like using the customer service robot 10 customized according to preference of the customer.

Note that, in this embodiment, it is possible to perform the setting change irrespective of whether the check-in user is a member of the customer service support system 1. If the check-in user is a nonmember, the personalize processing unit 1549 reflects change content on the customer service robot 10 without registering the change content in the user management table 3164. If the check-in user is a nonmember, the personalize processing unit 1549 may limit the setting change to be unable to be performed.

The action plan generating unit 1550 executes processing for supporting an action of the customer in the commercial facility. Specifically, the action plan generating unit 1550 narrows down destinations while checking a store visiting purpose and conditions acquired from the customer to generate an action plan including stores to be visited and a moving route in the commercial facility and proposes the action plan to the customer.

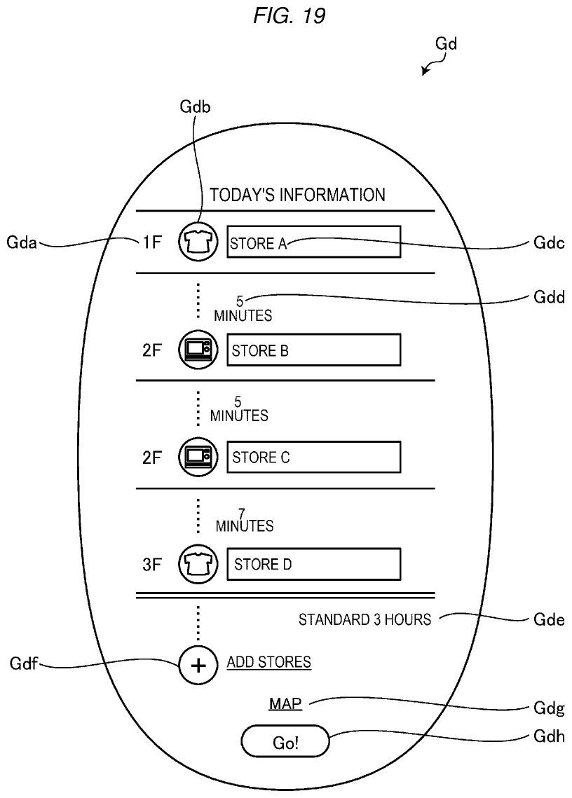

If receiving operation for deciding destination stores, the action plan generating unit 1550 generates, based on position information of each of the destination stores, the present position of the customer service robot 10, and the map information 3161, an action plan indicating a route to the destination stores. The action plan generating unit 1550 causes the front display unit 132 to display the action plan screen Gd (see FIG. 19) representing the generated action plan. Note that operation examples of the action plan generating unit 1550 are explained in detail below (see FIGS. 17 to 19).

If the customer service robot 10 arrived at a store specified in the action plan, the operation control unit 1544 tracks an elapsed time after the arrival at the store. If the tracked elapsed time approached or reached a staying time in the store specified in the action plan, the operation control unit 1544 informs the customer, via display or voice, that it is time to move to the next store.

The action plan includes, for each of the destination stores, at least information for specifying touring order of the destination store. The action plan may include information indicating presence positions (for example, floor numbers) of the destination stores. The action plan may include distances among the destination stores, times required for movement, staying times in the destination stores, and a total time obtained by totaling the moving times and the staying times.

In this case, a time uniform in the stores may be set as the staying times. Staying times corresponding to the destination stores and types of the destination stores may be set as the staying times based on an average value or the like of staying times calculated in advance for each of the stores and each of the types of the stores. Further, in the case of a configuration in which an action history is recorded in correlation with the user ID of the check-in user, staying times in the destination stores may be extracted from an action history in the past and an average value or the like of the extracted staying times may be set as a staying time.

A method of determining touring order of the destination stores does not particularly matter and a publicly-known technique such as route search can be used. The action plan generating unit 1550 may arrange the touring order as appropriate. For example, the action plan generating unit 1550 may arrange the destination stores in order of closeness from the present position. If a favorite commodity of the customer is present in a plurality of stores, a store at the shortest total moving distance may be selected to set the touring order by the action plan generating unit 1550. The action plan generating unit 1550 may arrange the destination stores in order for minimizing a waiting time taking into account congestion states and the like of the destination stores.

If determining that the customer service robot 10 reached the destination store, the operation control unit 1544 enables the store cooperation unit 1551 and causes the customer service robot 10 and the store device 20 provided in the destination store to cooperate. The store correlation unit 1551 accesses the store device 20 via the network N or short-range wireless communication to implement a state in which the customer service robot 10 is capable of operating in cooperation with the store device 20 of the destination store. For example, if the customer service robot 10 arrives at the destination store, the store cooperation unit 1551 accesses the store device 20 of the destination store to implement a state in which it is possible to refer to the commodity master 2191 and the like stored by the store device 20.

The operation control unit 1544 may cooperate with the store device 20 to cause an electronic shelf label to emit light. For example, if a task for causing an electronic shelf label in a display position of a commodity of a specific type to emit light is set in the destination store at which the customer service robot 10 arrived, the operation control unit 1544 cooperates with the store device 20 to cause the electronic shelf label in the display position to emit light. At that point, by causing the electronic shelf label to emit light in a light emission color set by the personalize processing unit 1549 explained below, it is possible to easily identify an electronic shelf label that emits light according to setting of another customer attended by another customer service robot 10.

Specifically, the store cooperation unit 1551 retrieves a commodity corresponding to a type set in the task from the commodity master 2191 and specifies a display position of the commodity. The store cooperation unit 1551 cooperates with the store device 20 and performs control for causing an electronic shelf label disposed in the specified display position to emit light.

Consequently, if reaching the destination store according to the leading of the customer service robot 10, the customer can easily grasp a display position of a commodity that the customer intends to purchase. Therefore, the customer service robot 10 can efficiently perform purchase support for the commodity that the customer intends to purchase.

The setting handover unit 1552 causes the customer service robot 10 and another customer service robot 10 to hand over various kinds of setting information of the robot management table 3163, the user management table 3164, the transaction management table 3165, and the like that are standards of a customer service action of the customer service robot 10.

The stores specified by the action plan sometimes include stores present in positions exceeding a movable range of the customer service robot 10. For example, movement across floors with different floor numbers is included in action patterns. In such a case, the operation control unit 1544 causes the customer service robot 10 to move to the floors with the different floor numbers using the elevator.

Specifically, the operation control unit 1544 performs wireless communication with the elevator to thereby call the elevator and designate a target floor number.

If an elevator is absent or the elevator cannot be used, the setting handover unit 1552 demands support of the customer service robot 10 in the standby mode present in a target floor. The setting handover unit 1552 hands over an action pattern set in the customer service robot 10 to another customer service robot 10 to continue to support an action of the customer. The customer service robot 10 on the support demanding side guides the customer to a boarding gate of an escalator. The customer service robot 10 causes the customer service robot 10 taking over the setting to move to an exit of an escalator with the target floor number. The customer moves to the target floor using the escalator. Thereafter, the customer service robot 10 present in the exit of the escalator continues the guidance for the customer.

Specifically, if the customer service robot 10 moves to the first store or the next store based on the action plan, the operation control unit 1544 determines whether a floor number of a floor where the customer service robot 10 is located and a floor number of a floor where the moving destination store is present are the same. If the floor numbers are the same, the operation control unit 1544 guides the customer to the moving destination store in the leading mode explained above.

On the other hand, if the floor numbers are different, the setting handover unit 1552 refers to the robot management table 3163 and searches for another customer service robot 10 that is present in the same floor number as the floor number of the moving destination store and a status of which is the standby mode. Subsequently, the setting handover unit 1552 hands over, to the found other customer service robot 10, the various data such as the user ID, the user features, the user setting, the action plan, and the local transaction management table of the check-in user stored in the customer service robot 10 and moves the other customer service robot 10 to a position that is a handover point.

Here, a data handover method does not particularly matter. For example, the setting handover unit 1552 may directly transmit data to the other customer service robot 10. For example, the setting handover unit 1552 may notify the robot ID of the customer service robot 10, the user ID of the check-in user, and the like to the other customer service robot 10 to cause the other customer service robot 10 to read data necessary for the handover from the various data tables of the server device 30. Alternatively, the setting handover unit 1552 may cause the server device 30 to transmit the various data tables of the server device 30 to the customer service robot 10 on the data handover side.

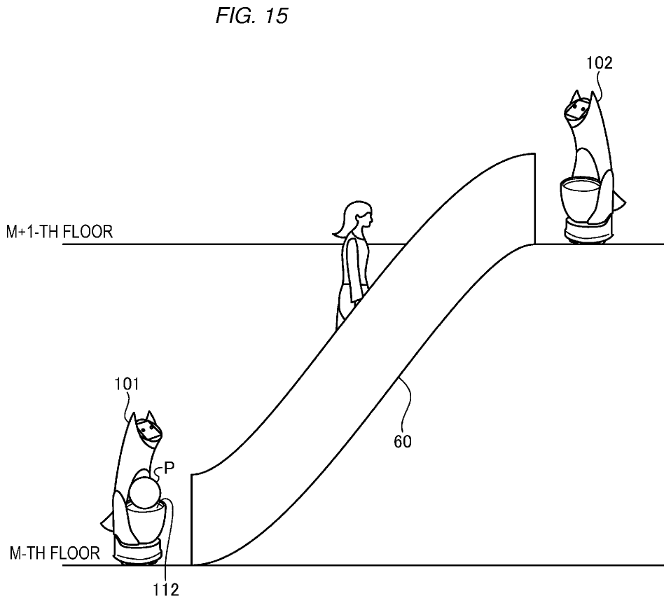

A more specific handover state is explained with reference to FIG. 15. FIG. 15 is a diagram for explaining a handover function of the customer service robot. In FIG. 15, a customer service robot 101 currently guiding a customer is present in an M-th floor. If a moving route for moving to an M+1-th floor is registered in a set action pattern and an elevator cannot be used because of congestion or a failure, the action plan generating unit 1550 proposes movement by an escalator 60 and guides the customer to a boarding gate of the escalator 60 on the M-th floor.

At this time, the setting handover unit 1552 of the customer service robot 101 demands the server device 30 to support a customer service robot on the M+1-th floor. The robot managing unit 3142 of the server device 30 receiving the demand searches for a customer service robot that is in a standby state on the M+1-th floor. The setting handover unit 1552 hands over various kinds of information used for the customer guidance by the customer service robot 101 to a customer service robot 102 found as a result of the search. The setting handover unit 1552 causes the customer service robot 102 to move to an exit of the escalator 60 on the M+1-th floor.

If an article such as a commodity P is placed on the placing table 112 of the customer service robot 101 that performed guidance to that point, the operation control unit 1544 of the customer service robot 101 may display a screen for urging the customer to carry the article and move by the escalator 60 and place the article on the new customer service robot 102 or may display a screen for instructing the customer to deposit the article at a reception counter or the like. In the latter case, if receiving the instruction for movement, the operation control unit 1544 of the customer service robot 101 conveys the article placed on the placing table 112 to the reception counter.

If moving to the M+1-th floor by the escalator 60, the customer faces the customer service robot 102 at the exit of the escalator 60. At this time, all of the various kinds of setting information of the customer service robot 101 that attended the customer to that point, for example, the user ID of the check-in user, the user setting, the action plan, and the local transaction management table were handed over to the customer service robot 102. Therefore, the customer does not need to perform check-in operation again. Thereafter, the customer is guided by the customer service robot 102 on the M+1-th floor.

Note that the handover of data between the customer service robots 10 is performed not only across floors with different floor numbers. For example, in floors with the same floor numbers, if floors to which the customer service robots 10 are movable are limited (for example, if there are steps in the same floor numbers), data may be handed over among the customer service robots 10 that are in charge of the floors. If the customer service robots 10 in charge are different between the commercial facility and the parking lot, data may be handed over between the different customer service robots 10 if the customer moves between the commercial facility and the parking lot. Further, if a battery of the customer service robot 10 is exhausted and the customer service robot 10 cannot move in the entire course of an action pattern, data may be handed over to another customer service robot 10.

The purchase supporting unit 1553 executes processing for supporting purchase of a commodity. For example, the purchase supporting unit 1553 executes, based on a commodity code read from a code symbol or a wireless tag, processing for registering a commodity corresponding to the commodity code as a purchase target. Specifically, if a commodity code is read by the read and write control unit 1543, the purchase supporting unit 1553 reads commodity information such as a commodity name and a price of a commodity corresponding to the commodity code from the commodity master 2191 and registers the commodity information in a data table (hereinafter referred to as local transaction management table as well) stored in the RAM 153 or the like. For example, the local transaction management table may the same data configuration as the transaction management table 3165 or may have a data configuration excluding the robot ID from the transaction management table 3165.

The purchase supporting unit 1553 executes, according to operation of the customer, settlement processing for a commodity registered in the local transaction management table. Specifically, the purchase supporting unit 1553 executes settlement processing for settling, with a payment amount of the customer, a total amount of commodities registered in the local transaction management table. If the settlement processing was completed, the purchase supporting unit 1553 gives a purchase completion flag in correlation with a commodity code of the settled commodity registered in the in the local transaction management table.

Note that it is assumed that a settlement method does not particularly matter and electronic settlement processing such as code settlement, credit settlement, and electronic money settlement can be performed. It is assumed that, if the customer service robot 10 includes a cash automatic adjustment machine, cash settlement can also be used.

If it assumed that, if the customer service robot 10 does not include a cash automatic adjustment machine, the purchase supporting unit 1553 transmits, via the network N or short-range wireless communication, data for settlement to an external device capable of performing cash settlement to cause the device to perform the cash settlement. For example, the purchase supporting unit 1553 transmits data for settlement in the store device 20 to the store device 20 to cause the store device 20 to perform the cash settlement. Note that a transmission destination of the data for settlement is not limited to the store device 20. The purchase supporting unit 1553 may transmit the data for settlement to a checkout machine for cash settlement provided in the commercial facility.

The purchase supporting unit 1553 may determine, according to states of external devices, an external device to be set as a transmission destination. For example, the purchase supporting unit 1553 may determine, according to the balances of change included in the external devices and states of use of the external devices, an external device to be set as a transmission destination. If causing the external device to perform settlement, the purchase supporting unit 1553 preferably cooperates with the operation control unit 1544 to lead the customer to the external device at the settlement destination.

Note that the purchase supporting unit 1553 outputs, according to completion of the settlement processing, a receipt showing details of the transaction. For example, if the customer service robot 10 includes a printer or if a printer is connected to the customer service robot 10, the purchase supporting unit 1553 controls the printer to cause the printer to output a receipt.

The purchase supporting unit 1553 may output the receipt in a form of an electronic receipt. In this case, the purchase supporting unit 1553 may transmit the electronic receipt to the customer terminal 50 paired with the customer service robot 10. The purchase supporting unit 1553 may transmit the electronic receipt to an address described in the user management table 3164.

In this case, the purchase supporting unit 1553 may output a receipt every time settlement processing is performed or may output the receipt for each of the stores. In the latter case, the purchase supporting unit 1553 may output the receipt if the customer service robot 10 leaves the store. Further, if the touring of all the stores specified in the action plan was completed, the purchase supporting unit 1553 may collectively output receipts of settlement processing performed in the respective stores. Note that the customer can select output timing for the receipt. The output timing for the receipt may be able to be set by personalize processing.

After updating the local transaction management table according to the registration of the commodity or the completion of the settlement processing, the purchase supporting unit 1553 transmits content of the updated local transaction management table to the server device 30 together with the robot ID of the customer service robot 10 and a transaction ID of the transaction to update the transaction management table 3165 of the server device 30. Consequently, the latest state of a transaction performed in each of the customer service robots 10 is reflected on the transaction management table 3165 of the server device 30. Note that, in this embodiment, the state of the transaction is stored in the transaction management tables of both of the customer service robot 10 and the server device 30. However, not only this, but the state of the transaction may be stored in one of the transaction management tables.

The purchase supporting unit 1553 includes a function for supporting the customer in selecting purchase candidate commodities. Specifically, the purchase supporting unit 1553 includes a recommendation function for selecting and presenting a commodity suitable for a taste of the customer as a purchase candidate.

For example, in a clothing store or the like, if a commodity to be set as a reference for recommendation is selected by reading a commodity code, the purchase supporting unit 1553 selects, based on information such as a size, a color, and design included in additional information of the commodity, a commodity set as a target of combination (substitution). The purchase supporting unit 1553 causes the front display unit 132 to display the selected commodity to present the selected commodity to the customer. It is possible to instruct, according to operation of the customer, to register the presented commodity as a purchase target or reject the presented commodity.

Note that a method of selecting a commodity does not particularly matter. A publicly-known technique concerning recommendation can be used. For example, the purchase supporting unit 1553 may select a commodity conforming to a purchase tendency and a taste of the customer based on a purchase history and the like stored in correlation with a user ID of the customer. In the example explained above, after the commodity set as the reference was selected, the purchase candidate commodities are selected based on the commodity. However, not only this, but the purchase candidate commodities may be selected from a commodity unselected state. In this embodiment, the purchase candidate commodities to be selected are store commodities in the store registered in the commodity master 2191 but are not limited to this.

In this embodiment, the purchase supporting unit 1553 limits a motion of the customer such that a commodity registered in the store cannot be taken out to the outside of the store until settlement is completed in the store. For example, the purchase supporting unit 1553 cooperates with the operation control unit 1544 to limit a motion such that the customer service robot 10 does not exit to the outside of the store until settlement is completed in all the registered store commodities. For example, if the customer service robot 10 is capable of moving to the outside of the store even if an unsettled store component is present, the purchase supporting unit 1553 stops, if the customer service robot 10 moves away from the store by a predetermined distance, movement of the customer service robot 10 and causes the front display unit 132 or the rear display unit 115 to display a screen for demanding settlement for the unsettled store commodities.

If an unsettled component is present among the registered store components, the purchase supporting unit 1553 may inform to that effect to call attention of a store clerk and the customer himself or herself. For example, by changing a color of the light emitting unit 141 or flashing the light emitting unit 141, the purchase supporting unit 1553 may inform that the unsettled store commodity is present. The purchase supporting unit 1553 may call attention of the store clerk by causing the rear display unit 115 to display states of registration and settlement of a commodity, for example, the number of registered items and the number of settled items of the commodity. The store clerk of the store or an employee of the commercial facility can easily grasp a state of a transaction such as presence or absence of an unsettled commodity by checking the display of the rear display unit 115.

Note that, if a provisional commodity was registered, the purchase supporting unit 1553 may enable settlement processing for the provisional commodity to be executed not only in the store but also after the customer left the store. Consequently, the customer can purchase a favorite commodity after comparing the provisional commodity and a similar commodity in another store.

Incidentally, it is possible to cause the customer service robot 10 to convey commodities purchased in the stores by placing the commodities on the placing table 112 included in the customer service robot 10. On the other hand, depending on a form of a commodity or an intension of a customer, it is also assumed that the customer does not receive a purchased commodity on the site and receives the commodity at another opportunity or in another place. For example, if a store is a showroom store, since commodities in the store are exhibited articles, a real object of a commodity cannot be received on the site. For example, if carried luggage and other commodities are placed on the placing table 112 of the customer service robot 10, a commodity purchased anew sometimes cannot be placed on the placing table 112.

Therefore, the purchase supporting unit 1553 may cause the front display unit 132 to display a screen (not illustrated) on which a method of receiving a commodity for which settlement processing was completed can be selected. On the screen on which the receiving method can be selected, choices such as mailing, counter reception, locker reception, exit reception, and parking lot reception are displayed. The purchase supporting unit 1553 specifies the receiving method by acquiring a selection result of the customer. Subsequently, the purchase supporting unit 1553 requests the customer to designate detailed information corresponding to the selected receiving method. For example, if the mailing was selected, the purchase supporting unit 1553 instructs the customer to input information concerning a mailing destination. If the counter reception, the locker reception, or the exit reception was designated, the purchase supporting unit 1553 instructs the customer to designate a specific position of a counter, a specific position of a locker, a specific position of an exit, or the like. Further, if the parking lot reception was designated, the purchase supporting unit 1553 checks whether the parking lot reception may be performed in a parking position of an automobile of the customer acquired from the parking lot system 40 via a server 30.

The communication control unit 1554 controls communication between the customer service robot 10 and the server device 30 and communication between the customer service robot 10 and the store device 20. As explained below, if the customer service robot 10 moves among floors with different floor numbers using an elevator, the communication control unit 1554 controls communication with the elevator.

Note that all of exchanges of data performed among different devices are performed by functions of communication control units included in the devices. However, since explanation is complicated, in the following operation explanation, explanation relating to the communication control unit 1554, the communication control unit 3143, and the communication control unit 2144 is omitted.

### (Specific Example of Check-In Processing)

An operation example of check-in processing is explained with reference to FIG. 16. FIG. 16 is a diagram illustrating an example of the check-in screen displayed on the front display unit of the customer service robot at a check-in time.

An image simulating a face including eyes and a nose is displayed on the check-in screen Ga. A message Gaa for urging check-in operation of a customer is displayed on the check-in screen Ga.

A check-in operation method does not particularly matter. However, an operation method for a customer (hereinafter referred to as member as well), whose user information is registered in the user management table 3164, and an operation method for a nonmember, whose user information is unregistered in the user management table 3164, are preferably prepared. In this embodiment, operation for inputting a user ID to the customer service robot 10 is set as check-in operation for a member. Touch operation on the check-in screen Ga is set as check-in operation for a nonmember. Note that, as an example of the check-in screen Ga illustrated in FIG. 16, an example is explained in which an image Gab for informing presentation of a two-dimensional code, in which a user ID is registered, to the customer terminal 50 of the customer in order to urge the customer to input the user ID.

Note that the image Gab may include information for informing that the customer service robot 10 is caused to read a code symbol displayed on the customer terminal 50. If a code symbol for check-in is displayed on the check-in screen Ga, the image Gab may include information informing the code symbol and informing that the code symbol is read by the customer terminal 50. In the latter case, it is preferable to include, in the code symbol displayed on the check-in screen Ga, information for pairing the customer terminal 50 with the customer service robot 10 as explained below. In this case, the operation control unit 1544 may acquire the user ID from the paired customer terminal 50 to receive input of the user ID.

For example, if the two-dimensional code displayed on the customer terminal 50 is held over the front imaging unit 1431, the user ID is read from the two-dimensional code by the read and write control unit 1543. If receiving input of the user ID via the read and write control unit 1543, the operation control unit 1544 retrieves the input user ID from the user management table 3164 to determine whether the customer is a member. If the input user ID is registered in the user management table 3164, the operation mode setting unit 1545 determines that check-in operation by the member was performed and shifts the operation mode of the customer service robot 10 from the standby mode to the customer service mode. Note that the operation control unit 1544 may issue a transaction ID if the operation mode is shifted to the customer service mode. The operation control unit 1544 acquires an image and a feature value of the customer, who performed the check-in operation, as user features from an image captured by the front imaging unit 1431 and stores the user features in the RAM 153 or the like in correlation with the input user ID. The operation control unit 1544 registers the present operation mode, the input user ID, and the user features in the robot management table 3163 in correlation with the robot ID of the customer service robot 10.

If receiving touch operation on the check-in screen Ga, the operation control unit 1544 determines that check-in operation was performed by the nonmember and shifts the operation mode of the customer service robot 10 from the standby mode to the customer service mode. In this case, the operation control unit 1544 locally stores user features of the customer, who performed the check-in operation, and registers the present operation mode and the user features in the robot management table 3163 in correlation with the robot ID of the customer service robot 10. In this case, the personalize processing unit 1549 may cause the front display unit 132 to display a screen for urging member registration.

Note that it is assumed that, even if the check-in operation by the touch operation was performed, during the customer service mode, it is possible to shift to a check-in state by the member by inputting the user ID at any timing.

It is assumed that the operation control unit 1544 is capable of establishing communication (pairing) by short-range wireless communication with the customer terminal 50 irrespective of whether a checked-in customer (hereinafter referred to as check-in user as well) is a member. In this case, for example, the operation control unit 1544 causes the front display unit 132 to display, in a form of a two-dimensional code, setting information for pairing with the customer service robot 10 and reads setting information of the customer terminal 50 via the read and write control unit 1543. If the customer service robot 10 was paired with the customer terminal 50, the operation control unit 1544 captures the position of the check-in user and the distance to the customer service robot 10 based on RSSI (reception signal intensity) or the like and transmits and receives various kinds of information. For example, the customer terminal 50 may be used as a remote controller device that controls the customer service robot 10.

A pairing target is not limited to the customer terminal 50 and may be a simpler beacon terminal. In this case, the beacon terminal may be rent out from the commercial facility or may be detachably provided in the customer service robot 10. If the customer service robot 10 was paired with the beacon terminal, the operation control unit 1544 captures the position of the check-in user and the distance to the customer service robot 10 based on RSSI (reception signal intensity) or the like and transmits and receives various kinds of information. By imparting a remote controller function to the beacon terminal, the beacon terminal may be used as a remote controller device that controls the customer service robot 10.

### (Specific Examples of the Action Plan Setting)

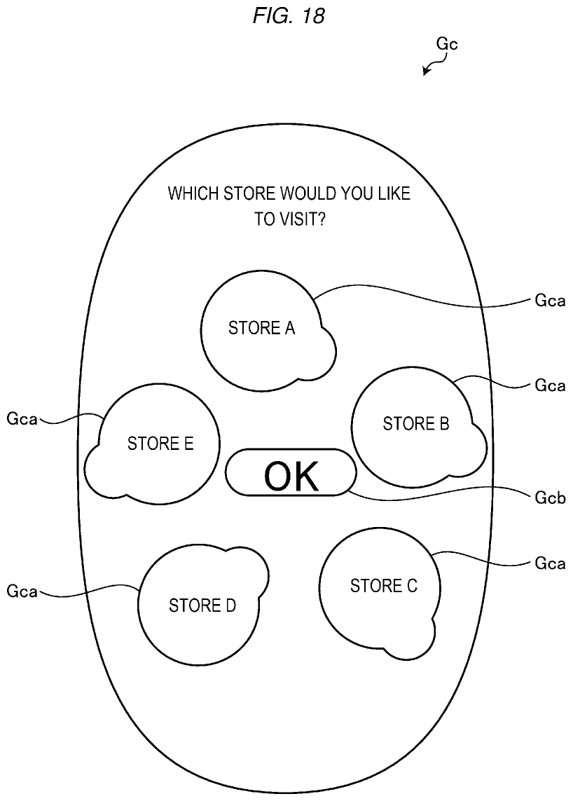

Specific examples of the action plan setting are explained with reference to FIGS. 17 to 19. FIG. 17 is a diagram illustrating an example of a screen displayed on the front display unit of the customer service robot if a customer instructs a store visiting purpose. FIG. 18 is a diagram illustrating an example of a screen displayed on the front display unit of the customer service robot if the customer selects a store that the customer desires to visit. FIG. 19 is a diagram illustrating an example of schematic information of a generated moving route displayed on the front display unit of the customer service robot.

The action plan generating unit 1550 causes the front display unit 132 to display a store visiting purpose check screen Gb illustrated in FIG. 17 in order to check a purpose of a customer. On the store visiting purpose check screen Gb, a plurality of choices Gba indicating types of purposes set based on the store types of the stores and the keywords registered in the store management table 3162. For example, as illustrated in FIG. 17, rough objectives such as “want to buy”, “want to play”, and “want to eat” are displayed as the choices Gba. For example, any one of the choices Gba can be selected. After any one of the choices Gba was selected, if the selection is decided by operation of an operation piece Gbb in the center, the action plan generating unit 1550 causes the front display unit 132 to display a store check screen Gc in order to further narrow down purposes of the selected choice Gba.

A plurality of choices Gca indicating stores where a purpose selected on the immediately preceding store visiting purpose check screen Gb can be achieved are displayed on the store check screen Gc. FIG. 18 is an example of the store check screen Gc and illustrates an example of a case in which the choice Gba of “want to buy” was selected from the store visiting purpose check screen Gb illustrated in FIG. 17.

As another example, types and the like of commodities that can be purchased in the commercial facility may be displayed in the choices Gca of the store check screen Gc. In this case, if a type of a commodity is selected via the choice Gca and the selection decided by operation of an operation piece Gcb, the action plan generating unit 1550 may further cause the front display unit 132 to display a new store check screen Gc in which a store name of a store that sells the commodity of the selected type is a choice. In this way, the action plan generating unit 1550 narrows down the purpose of the customer stepwise to determine a store set as a destination matching the purpose (hereinafter referred to as destination store as well).

Note that the number of times the narrow-down is performed using the store visiting purpose check screen Gb and the store check screen Gc does not particularly matter. For example, the number of times the narrow-down is performed may be different for each of purposes. In the example explained above, the destination store is selected at the final stage of the narrow-down. However, the number of selectable stores is not limited to one and may be two or more.

The action plan generating unit 1550 may automatically determine a destination store from conditions of a selected purpose. In this case, the action plan generating unit 1550 may determine one or a plurality of destination stores based on characteristic information, a purchase history, and the like stored in correlation with a user ID of a check-in user.

After a destination store was determined for a certain purpose on the store visiting purpose check screen Gb, it is also possible to determine a destination store relating to a different purpose by returning to the first or immediately preceding check screen Gb.

FIG. 19 is an example of the action plan screen Gd. Store names of destination stores specified in an action plan and order for touring the destination stores are displayed on the action plan screen Gd. In FIG. 19, an example is illustrated in which touring in the order of a store A, a store B, a store C, and a store D is displayed. In the example illustrated in FIG. 19, a floor number Gda of a destination store, a commodity icon Gdb indicating a representative commodity sold in the store, a store name Gdc, a time Gdd required for movement between stores, and a total required time Gde are also displayed.

The customer can check destination stores and order of the destination stores by viewing the action plan screen Gd. On the action plan screen Gd, as explained below, the order of the destination stores can be changed and the destination stores can be deleted according to operation of the customer.

For example, if operation for moving the customer service robot 10 to a position between other destination stores was performed on the action plan screen Gd illustrated in FIG. 19 in a state in which any one of destination stores was long-pressed, the action plan generating unit 1550 updates the action plan by inserting the long-pressed destination store in the position to which the customer service robot 10 was moved. For example, if click operation was performed on any one of the destination stores (for example, the store C) on the action plan screen Gd illustrated in FIG. 19, the action plan generating unit 1550 deletes the operation target destination store and updates the action plan.

On the action plan screen Gd, a destination store can be also added according to operation of the customer. For example, if receiving operation of an operation piece Gdf, the action plan generating unit 1550 displays, on the front display unit 132, a screen on which a destination store can be added. For example, such a screen may be a screen on which store names capable of directly designating stores are displayed as a list or may be the store visiting purpose check screen explained above.

An operation piece Gdg for displaying a map of the commercial facility is provided on the action plan screen Gd. If receiving operation of the operation piece Gdg, the action plan generating unit 1550 causes, based on the map information 3161, the front display unit 132 to display a screen (not illustrated) showing positions of destination stores on the map of the commercial facility. The action plan generating unit 1550 may cause the front display unit 132 to display a map applied with processing for adding numbers indicating order of touring the positions of the destination stores and highlighting moving routes among the destination stores.

An operation piece Gdh for instructing to start movement to a destination store is provided on the action plan screen Gd. If the operation piece Gdh was operated, the operation mode setting unit 1545 shifts the operation mode of the customer service robot 10 to the leading mode. Note that the operation control unit 1544 may issue a transaction ID at timing when the action plan is generated or timing when the start of movement to the destination store is instructed.

Note that, on the action plan screen Gd, by selecting a store name and the like of a displayed destination store, it is also possible to set processing content executed if the customer service robot 10 reaches the destination store. For example, processing for causing an electronic shelf label of a shelf, on which a commodity of a type selected on the store visiting purpose selection screen is displayed, to emit light if the customer service robot 10 arrives at the destination store can be set as a task. The task set for the destination store is executed by control of the operation control unit 1544 if the customer service robot 10 arrives at the destination store.

The task specifies processing requested from the customer and is executed at preset timing. For example, the task can be represented by a set of an execution condition and processing content. In the case of the example explained above, the execution condition is specified by a set of a “store name” of a store where the processing is executed and an “arrival time at the store” for specifying execution timing of the processing. In the processing content, for example, a command for instructing light emission of an electronic shelf label is set together with, for example, a commodity code representing the type of the commodity selected on the store visiting purpose selection screen. The processing content of the task set for the destination store is executed by the control of the operation control unit 1544 based on the execution condition of the task. Note that an execution condition and processing content that can be set as the task are not limited to this.

### (Screen Examples Displayed on the Robot During Movement in the Customer Service Mode)

Screen examples displayed on the front display unit 132 and the rear display unit 115 while the customer service robot 10 in the state of the customer service mode is moving are explained with reference to FIGS. 20 to 23. FIG. 20 is a diagram illustrating an example of a screen displayed on the front display unit if the customer service robot is operating in the leading mode. FIG. 21 is a diagram illustrating an example of a screen displayed on the rear display unit if the customer service robot is operating in the leading mode. FIG. 22 is a diagram illustrating an example of a screen displayed on the front display unit if the customer service robot is operating in the following mode. FIG. 23 is a diagram illustrating an example of a screen displayed on the rear display unit if the customer service robot is operating in the following mode.

The operation control unit 1544 causes the display control unit 1541 to display information corresponding to a moving form of the customer service robot 10, for example, the leading mode and the following mode.

For example, if the customer service robot 10 is operating in the leading mode, the operation control unit 1544 causes the front display unit 132 to display the notice screen Ge illustrated in FIG. 20.

On the notice screen Ge, guidance information Gea indicating that the customer is being guided and a store name Geb (in this case, the store A) at a moving destination are displayed.

At this time, the operation control unit 1544 causes the rear display unit 115 to display the guidance screen Gf illustrated in FIG. 21.

On the guidance screen Gf, a store name Gfa (in this case, the store A) at a moving destination and a message indicating that guidance is being performed are displayed. On the guidance screen Gf, an arrow Gfb indicating a direction in which the customer service robot 10 moves and a distance Gfc to the store at the moving destination are displayed. On the guidance screen Gf, peripheral information Gfd indicating common spaces present around the present position of the customer service robot 10 is displayed in an upper part of the screen. Positions where the peripheral information Gfd is displayed in the screen correspond to, based on, for example, the present position and a moving method of the customer service robot 10, directions in which the respective common spaces are present. For example, an example illustrated in FIG. 21 indicates that a vending machine is present on the right side of a traveling direction of the customer service robot 10 and a baby resting room is present on the left side of the traveling direction of the customer service robot 10. FIG. 21 indicates that a rest room, a resting place, and a locker are present in the traveling direction of the customer service robot 10. Display positions of icons indicating these kinds of peripheral information Gfd change according to the traveling direction of the customer service robot 10.

The operation control unit 1544 may perform guidance by voice output without being limited to the guidance by the screen display. For example, the operation control unit 1544 may output voice for guiding movement to a destination store simultaneously with displaying the guidance screen Gf.

For example, if the customer service robot 10 is operating in the following mode, the operation control unit 1544 causes the front display unit 132 to display the notice screen Gg illustrated in FIG. 22.

On the notice screen Gg, notice information Gga indicating that the customer service robot 10 is following the customer and a store name Ggb (in this case, the store A) at a moving destination are displayed.

At this time, the operation control unit 1544 causes the rear display unit 115 to display the information display screen Gh illustrated in FIG. 23.

The number of registered commodity items Gha and the number of settled commodity items Ghb are displayed on the information display screen Gh. The number of registered commodity items Gha is the number of items of commodities registered by the customer during the guidance by the customer service robot 10. The number of settled commodity items Ghb is the number of items of commodities for which settlement was completed among registered commodities. An example illustrated in FIG. 23 indicates that two items of commodities were registered and one item of the two items of the commodities was settled (that is, one item was unsettled).

Since the number of registered commodity items Gha and the number of settled commodity items Ghb are displayed, a store clerk of a store and an employee of the commercial facility can easily grasp a state of a transaction, for example, whether an unsettled commodity is present.

A lower part of the information display screen Gh is a free display space. Various kinds of information such as advertisement information Ghc of the commercial facility and a store and an elapsed time after a customer visited the store are displayed in the display space.

### (Various Screen Examples Displayed on the Customer Service Robot During Shopping)

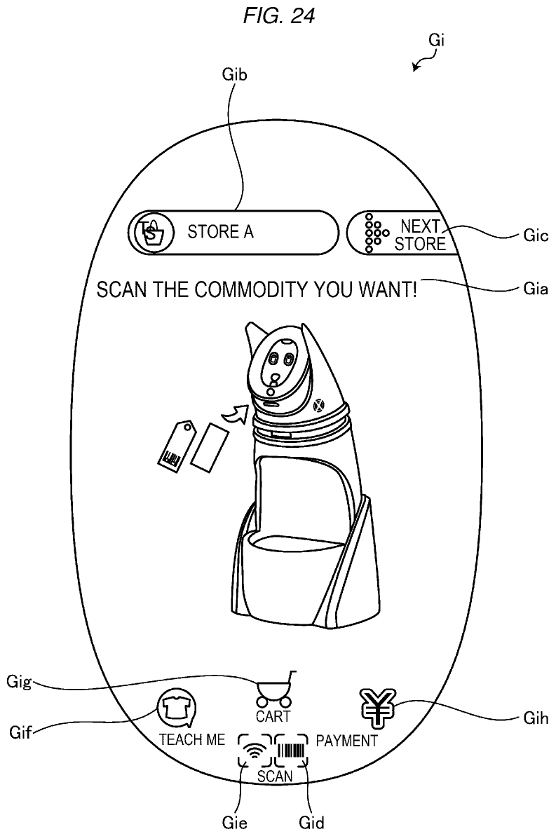

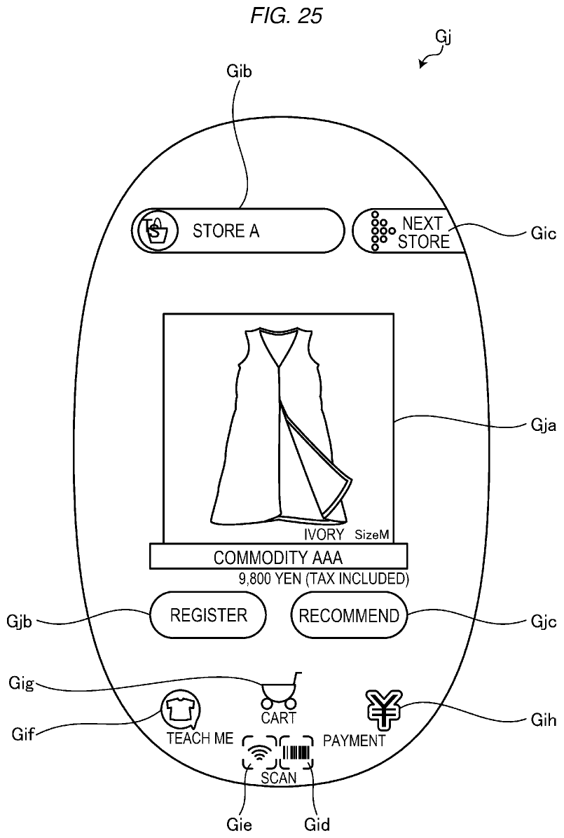

Specific operation examples of the purchase supporting unit 1553 are explained with reference to FIGS. 24 and 25. FIG. 24 is a diagram illustrating an example of a basic operation screen. FIG. 25 is a diagram illustrating an example of a commodity screen.

If the customer service robot 10 arrived at a store and shifted to the following mode, the purchase supporting unit 1553 causes the front display unit 132 to display a basic operation screen Gi illustrated in FIG. 24 and stands by for operation of a customer.

A message Gia for urging reading of an image and an image for explaining a reading method are displayed on the basic operation screen Gi. A store name Gib of the store that the customer is staying and an operation piece Gic explained below are provided in an upper part of the basic operation screen Gi.

Images Gid and Gie are displayed in a lower part of the basic operation screen Gi. The image Gid is an icon indicating that reading of a code symbol is possible. The image Gie is an icon indicating that reading of a wireless tag is possible.

Note that the images Gid and Gie may be operation pieces for enabling a hardware configuration relating to a reading function. For example, if one icon of the images Gid and Gie is touched, the purchase supporting unit 1553 may perform, according to the touched icon, control for enabling the imaging unit 143 or the reader writer unit 157.

Operation pieces Gif, Gig, and Gih are displayed on the basic operation screen Gi. The operation piece Gif is an operation piece for performing an inquiry to a store clerk in the store. The operation piece Gig is an operation piece for checking a registered commodity. If the operation piece Gig was operated, a virtual basket image (not illustrated) on which a commodity image, a commodity name, a price, and the like of a commodity registered at that point in time are displayed is displayed. The operation piece Gih is an operation piece for instructing a start of settlement processing.

Note that, if the operation piece Gif was operated, the purchase supporting unit 1553 cooperates with the store device 20 to execute processing for requesting the store clerk of the store to attend the customer. For example, the store cooperation unit 1551 transmits the position of the customer service robot 10 and information for designating an inquiry target commodity to the store device 20 to request the store clerk of the store to attend the customer. In this case, the store device 20 notifies, for example, the position of the customer service robot 10 to a terminal carried by the store clerk of the store and urges the store clerk to attend the customer.

If receiving input of a commodity code by reading a code symbol or a wireless tag, the purchase supporting unit 1553 causes the front display unit 132 to display, for example, a commodity screen Gj illustrated in FIG. 25.

The commodity screen Gj includes the various operation pieces of the basic operation screen Gi explained above. A region Gja for displaying a commodity image is provided in the center of the commodity screen Gj. The purchase supporting unit 1553 reads commodity information corresponding to the input commodity code from the commodity master 2191 and causes the front display unit 132 to display a commodity image included in a read data entry in the region Gja. The purchase supporting unit 1553 executes commodity registration processing based on the read data entry.

In FIG. 25, a state in which a commodity AAA was read is illustrated. A commodity image indicating the exterior of the commodity AAA is displayed in the region Gja. A commodity name, a price, and the like of the commodity AAA are displayed near the region Gja.

An operation piece Gjb and an operation piece Gjc are provided on the commodity screen Gj. The operation piece Gjb is an operation piece for instructing commodity registration processing for a commodity displayed in the region Gja of the commodity screen Gj. The operation piece Gjc is an operation piece for instructing execution of a recommendation function. If receiving operation of the operation piece Gjb, the purchase supporting unit 1553 performs, based on an input commodity code, commodity registration processing (hereinafter referred to as commodity registration as well) for registering commodity information of a commodity corresponding to the commodity code in a local transaction management table. If receiving operation of the operation piece Gjc, the purchase supporting unit 1553 selects, based on, for example, additional information of the commodity displayed in the region Gja, from the commodity master 2191, a commodity to be combined (for example, coordinated) with the commodity AAA (hereinafter referred to as recommended commodity as well). The purchase supporting unit 1553 causes, based on a data entry of the selected commodity, the front display unit 132 to display the commodity screen Gj representing a commodity image and the like of the commodity.

Although not illustrated, an operation piece for instructing virtual try-on of the commodity displayed in the region Gja may be provided side by side with the operation pieces Gjb and Gjc. If receiving operation of the operation piece, the purchase supporting unit 1553 generates a synthesized image obtained by superimposing the commodity image of the commodity displayed in the region Gja on an image of the customer captured by the front imaging unit 1431. The purchase supporting unit 1553 causes the front display unit 132 to display the generated synthesized image in the region Gja or on another screen to implement the virtual try-on. Note that a publicly-known technique can be used for processing relating to the virtual try-on.

The purchase supporting unit 1553 proposes, based on the commodity selected by the customer, as a purchase candidate, a commodity that can be combined with the commodity. If the customer likes the proposed candidate commodity, the purchase supporting unit 1553 can register the candidate commodity as a purchaser target commodity.

### (Flow of Processing Performed by the Customer Service Robot)

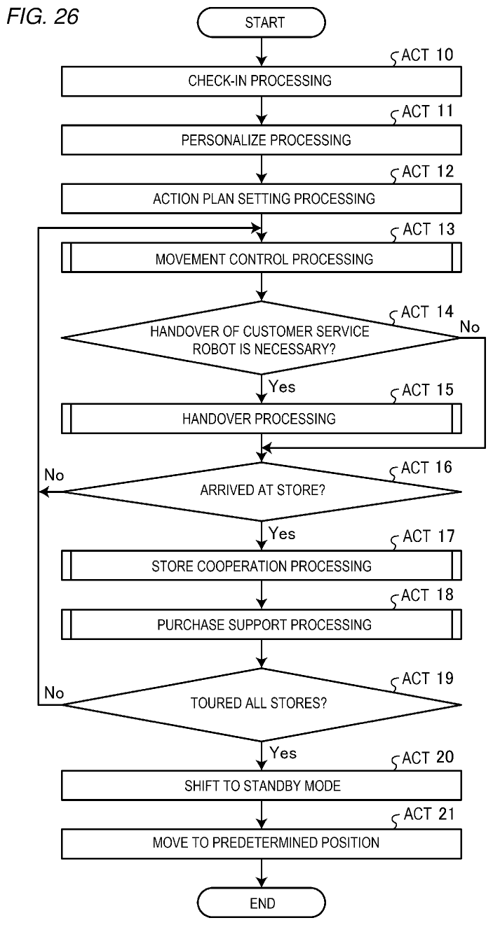

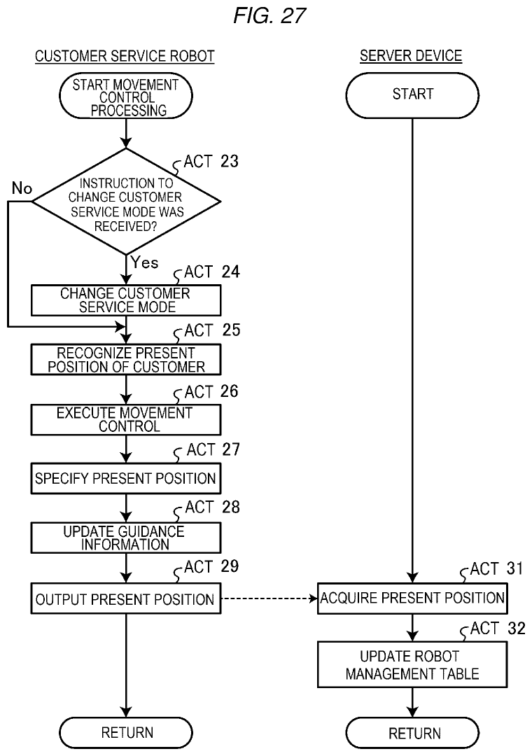

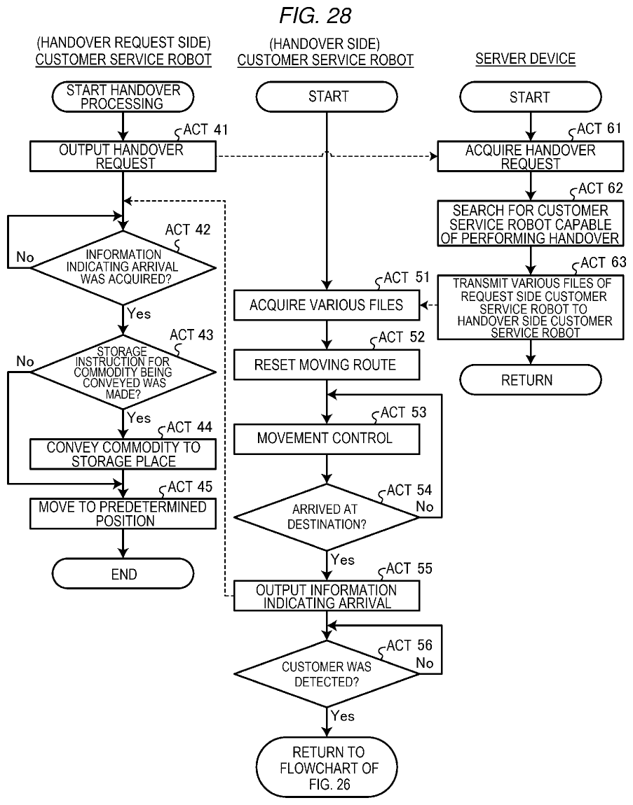

A flow of processing performed by the customer service robot 10 in the embodiment is explained with reference to FIG. 26. FIG. 26 is a flowchart illustrating an example of the flow of the processing performed by the customer service robot.

The operation control unit 1544 performs the check-in processing explained above (Act 10). Detailed explanation of specific processing is omitted.

The personalize processing unit 1549 performs the personalize processing explained above (Act 11). Detailed explanation of specific processing is omitted.

The action plan generating unit 1550 performs the action plan setting processing for setting the action plan explained above (Act 12). Detailed explanation of specific processing is omitted.

The operation control unit 1544 performs movement control processing for causing the customer service robot 10 to move according to the action plan (Act 13). A detailed flow of the movement control processing is explained below (see FIG. 27).

The setting handover unit 1552 determines whether handover of the customer service robot 10 is necessary (Act 14). The setting handover unit 1552 determines that the handover is necessary, for example, if a moving route generated by the action plan generating unit 1550 involves movement between different floors and movement by an elevator is difficult or if the battery of the customer service robot 10 was exhausted. If it is determined that the handover of the customer service robot 10 is necessary (Yes in Act 14), the processing proceeds to Act 15. On the other hand, if it is not determined that the handover of the customer service robot 10 is necessary (No in Act 14), the processing proceeds to Act 16.

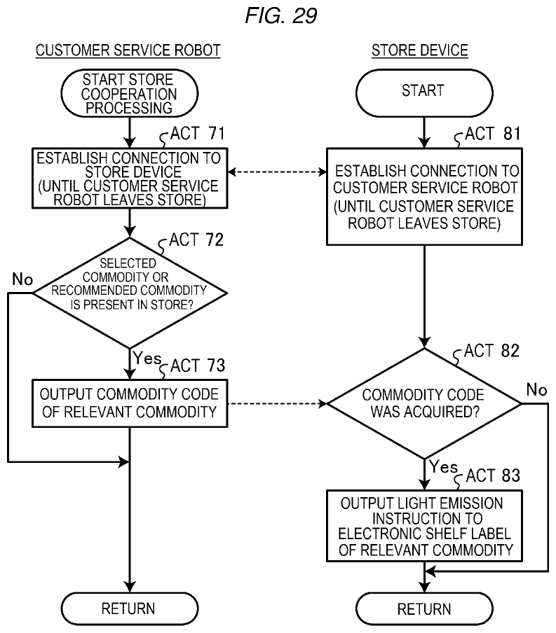

If it is determined in Act 14 that the handover is necessary, the setting handover unit 1552 performs handover processing for the customer service robot 10 (Act 15). A detailed flow of the handover processing is explained below (see FIG. 28).

Subsequently to Act 15, the operation control unit 1544 determines whether the customer service robot 10 arrived at a store that a customer visits next (Act 16). If it is determined that the customer service robot 10 arrived at the store, (Yes in Act 16), the processing proceeds to Act 17. On the other hand, if it is not determined that the customer service robot 10 arrived at the store (No in Act 16), the processing returns to Act 13.

If it is determined in Act 16 that the customer service robot 10 arrived at the store, the store cooperation unit 1551 cooperates with the store device 20 of the store visited by the customer to thereby perform the store cooperation processing for, for example, causing an electronic shelf label to emit light as explained above (Act 17). A detailed flow of the store cooperation processing is explained below (see FIG. 29).

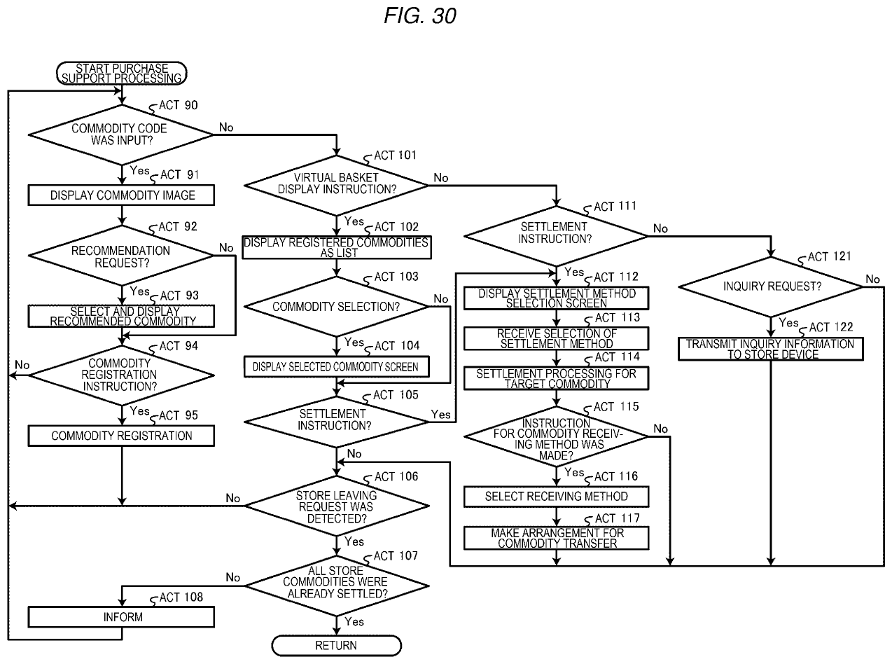

Subsequently, the purchase supporting unit 1553 performs purchase support processing for supporting purchase of a commodity (Act 18). A detailed flow of the purchase support processing is explained below (see FIG. 30).

The operation control unit 1544 refers to the action plan generated by the action plan generating unit 1550 to thereby determine whether the customer service robot 10 toured all the stores (Act 19). For example, if receiving check-out operation, the operation control unit 1544 determines that the customer service robot 10 toured all the stores. It is determined that the customer service robot 10 toured all the stores (Yes in Act 19), the processing proceeds to Act 20. On the other hand, if it is not determined that the customer service robot 10 toured all the stores (No in Act 19), the processing returns to Act 13.

If it is determined in Act 19 that the customer service robot 10 toured all the stores, the operation control unit 1544 clears the various data stored by the customer service robot 10 and causes the customer service robot 10 to shift to the standby mode (Act 20).

Subsequently, the operation control unit 1544 causes the customer service robot 10 to move to a predetermined position in the commercial facility. Note that the predetermined position may be the entrance of the commercial facility where the customer service robots 10 are collected or may be a charging area for charging the battery of the customer service robot 10 after use. Note that a store clerk may perform, with remote operation, operation for returning the customer service robot 10 to the predetermined position. Note that the remote operation for returning the customer service robot 10 to the predetermined position may be separately performed for the individual customer service robots 10 or may be operation for collectively returning a plurality of customer service robots 10 to the predetermined position. Thereafter, if arriving at the predetermined position, the customer service robot 10 ends the processing illustrated in FIG. 26.

### (Flow of the Movement Control Processing Performed by the Customer Service Support System)

A flow of the movement control processing is explained with reference to FIG. 27. FIG. 27 is a flowchart illustrating an example of the flow of the movement control processing.

The customer service robot 10 cooperates with the server device 30 to thereby perform the movement control processing. First, a flow of the processing performed by the customer service robot 10 is explained.

The operation control unit 1544 (the operation mode setting unit 1545) determines whether the operation receiving unit 1542 received an instruction to change the customer service mode (here, an instruction to change the leading mode and the following mode) (Act 23). Note that the operation receiving unit 1542 receives a direct instruction from the customer via the interface unit 13 or receives an instruction from a paring device, whereby the operation control unit 1544 determines that the operation receiving unit 1542 received the instruction to change the customer mode of the customer service robot 10. For example, if the customer service robot 10 arrived at the store, the operation control unit 1544 determines that the operation receiving unit 1542 received an instruction to change from the leading mode to the following mode. Further, while being triggered by leaving of the customer from the store, the operation control unit 1544 determines that the operation receiving unit 1542 received an instruction to change from the following mode to the leading mode. If it is determined that the operation receiving unit 1542 received the instruction to change the customer service mode (Yes in Act 23), the processing proceeds to Act 24. On the other hand, if it is not determined that the operation receiving unit 1542 received the instruction to change the customer service mode (No in Act 23), the processing proceeds to Act 25.

If it is determined in Act 23 that the operation receiving unit 1542 received the instruction to change the customer service mode, the operation control unit 1544 changes the customer service mode from the leading mode to the following mode or from the following mode to the leading mode (Act 24). Note that, if arriving at a store, the customer service robot 10 may automatically shift to the following mode without waiting for an instruction of the customer.

The operation control unit 1544 (the customer detecting unit 1547) recognizes a presence position of the customer out of an image captured by the imaging unit 143 (Act 25). Note that the customer detecting unit 1547 can more efficiently recognize the presence position of the customer by also using a presence position of the customer terminal 50 or a presence position of the beacon terminal explained above.

The operation control unit 1544 (the movement control unit 1548) executes movement control for causing the customer service robot 10 to move in the leading mode or the following mode in a state in which a positional relation with the customer recognized in Act 25 is kept constant (Act 26). Note that, at this time, if an obstacle is present in the traveling direction, the movement control unit 1548 also performs movement control for, for example, causing the customer service robot 10 to temporarily stop before the obstacle or move while avoiding the obstacle.

The operation control unit 1544 specifies (dead-reckons) a present position of the customer service robot 10 in the commercial facility based on a positioning result of the positioning unit 159, speed and a moving direction of the customer service robot 10 detected by the sensor unit 158, and the map information 3161 (Act 27).

The operation control unit 1544 updates, based on the present position of the customer service robot 10 specified in Act 27, guidance information to be displayed on the guidance screen Gf (Act 28).

The operation control unit 1544 outputs the present position of the customer service robot 10 specified in Act 27 to the server device 30 (Act 29). Thereafter, the customer service robot 10 ends the movement control processing and returns to a main routine illustrated in FIG. 26.

Subsequently, a flow of processing performed by the server device 30 is explained.

The information managing unit 3141 acquires the present position from the customer service robot 10 (Act 31).

The information managing unit 3141 stores the acquired present position of the customer service robot 10 in the robot management table 3163 to thereby update the robot management table 3163 (Act 32). Thereafter, the server device 30 ends an operation relating to the movement control processing.

### (Flow of the Handover Processing Performed by the Customer Service Support System)

A flow of the handover processing is explained with reference to FIG. 28. FIG. 28 is a flowchart illustrating an example of the flow of the handover processing.

The customer service robot 10 on a handover request side (the customer service robot 101 illustrated in FIG. 15) performs the handover processing by, for example, cooperating with the server device 30 and the customer service robot 10 on a handover side. First, a flow of processing performed by the customer service robot 10 on the handover request side is explained.

The setting handover unit 1552 of the customer service robot 10 on the handover request side outputs a handover request to the server device 30 (Act 41).

The setting handover unit 1552 of the customer service robot 10 on the handover request side determines whether information indicating that the customer service robot 10 on the handover side arrived at a handover point was acquired from the customer service robot 10 on the handover side (Act 42). If it is determined that the information indicating that the customer service robot 10 moved to the handover point was acquired (Yes in Act 42), the processing proceeds to Act 43. On the other hand, if it is not determined that the information indicating that the customer service robot 10 on the handover side arrived at the handover point was acquired (No in Act 42), Act 42 is repeated.

If it is determined in Act 42 that the information indicating that the customer service robot 10 on the handover side arrived at the handover point was acquired, the setting handover unit 1552 of the customer service robot 10 on the handover request side determines whether a storage instruction for a commodity being conveyed was made from the customer (Act 43). If it is determined that the storage instruction for the commodity was made (Yes in Act 43), the processing proceeds to Act 44. On the other hand, if it is not determined that the storage instruction for the commodity was made (No in Act 43), the processing proceeds to Act 45.

If it is determined in Act 43 that the storage instruction for the commodity was made, the operation control unit 1544 (the movement control unit 1548) of the customer service robot 10 on the handover request side conveys the commodity to a storage place (a counter or the like) designated from the customer (Act 44).

If the conveyance of the commodity ended, the operation control unit 1544 of the customer service robot 10 on the handover request side moves to a predetermined position (Act 45). Similarly, if it is not determined in Act 43 that the storage instruction for the commodity was made, the operation control unit 1544 of the customer service robot 10 on the handover request side moves to the predetermined position (Act 45). Thereafter, the customer service robot 10 on the handover request side ends the handover processing.

Subsequently, a flow of processing performed by the server device 30 is explained.

The robot managing unit 3142 acquires a handover request from the customer service robot 10 on the handover request side (Act 61).

The robot managing unit 3142 refers to the robot management table 3163 of the customer service robot 10 on the handover request side and checks the present position of the customer service robot 10 on the handover request side and a set moving route. The robot managing unit 3142 searches for the customer service robot 10 on the handover side capable of performing handover (Act 62).

The robot managing unit 3142 transmits various files (the robot management table 3163, the user management table 3164, the transaction management table 3165, and the like) of the customer service robot 10 on the handover request side to the customer service robot 10 on the handover side (Act 63). Thereafter, the server device 30 ends an operation relating to the handover processing.

Subsequently, a flow of processing performed by the customer service robot 10 on the handover side (the customer service robot 102 illustrated in FIG. 15) is explained.

The setting handover unit 1552 of the customer service robot 10 on the handover side acquires the various files (the robot management table 3163, the user management table 3164, the transaction management table 3165, and the like) from the server device 30 (Act 51).

The action plan generating unit 1550 of the customer service robot 10 on the handover side resets a moving route that passes the handover point from the present position and, thereafter, traces an action pattern generated by the customer service robot 10 on the handover request side (Act 52).

The operation control unit 1544 (the movement control unit 1548) of the customer service robot 10 on the handover side performs movement control for moving the customer service robot 10 on the handover side to the handover point (Act 53).

The operation control unit 1544 of the customer service robot 10 on the handover side determines whether the customer service robot 10 on the handover side arrived at a destination (the handover point) (Yes in Act 54). If it is determined that the customer service robot 10 on the handover side arrived at the handover point (Yes in Act 54), the processing proceeds to Act 55. On the other hand, if it is not determined that the customer service robot 10 on the handover side arrived at the handover point (No in Act 54), the processing returns to Act 53.

If it is determined in Act 54 that the customer service robot 10 on the handover side arrived at the handover point, the setting handover unit 1552 of the customer service robot 10 on the handover side outputs, to the customer service robot 10 on the handover request side, information indicating that the customer service robot 10 on the handover side arrived at the handover point (Act 55).

Subsequently, the operation control unit 1544 (the customer detecting unit 1547) of the customer service robot 10 on the handover side determines whether a customer to be attended was detected (Act 56). If it is determined that the customer was detected (Yes in Act 56), the customer service robot 10 on the handover side ends the handover processing, returns to the flowchart of FIG. 26, and continues the customer service. On the other hand, if it is not determined that the customer was found (No in Act 56), the Act 56 is repeated.

### (Flow of the Store Cooperation Processing Performed by the Customer Service Support System)

A flow of the store cooperation processing is explained with reference to FIG. 29. FIG. 29 is a flowchart illustrating an example of the flow of the store cooperation processing.

The customer service robot 10 cooperates with the store device 20 to thereby perform the store cooperation processing. A flow of processing performed by the customer service robot 10 is explained.

If the customer service robot 10 entered a store, the store cooperation unit 1551 establishes connection in order to exchange information between the communication unit 160 of the customer service robot 10 and the communication unit 217 of the store device 20 (Act 71). Note that the connection established here is maintained until the customer service robot 10 leaves the store.

The store cooperation unit 1551 determines whether a commodity selected by the customer or a favorite commodity of the customer is present in the store (Act 72). Specifically, the store cooperation unit 1551 determines, for example, based on contents of the robot management table 3163 and the user management table 3164 acquired from the server device 30 and content of the commodity master 2191, whether a commodity selected by the customer or a favorite commodity of the customer is present in the store (not illustrated in FIG. 29). If it is determined that the relevant commodity is present in the store (Yes in Act 72), the processing proceeds to Act 73. On the other hand, if it is not determined that the relevant commodity is present in the store (No in Act 72), the customer service robot 10 ends the store cooperation processing and returns to the main routine illustrated in FIG. 26.

If it is determined in Act 72 that the relevant commodity is present in the store, the store cooperation unit 1551 outputs a commodity code of the relevant commodity to the store device 20 (Act 73). Thereafter, the customer service robot 10 ends the store cooperation processing and returns to the main routine illustrated in FIG. 26.

Subsequently, a flow of processing performed by the store device 20 is explained.

The communication control unit 2144 establishes connection in order to exchange information between the communication unit 217 of the store device 20 and the communication unit 160 of the customer service robot 10 (Act 81). Note that the connection established here is maintained until the customer service robot 10 leaves the store.

The robot cooperation unit 2142 determines whether a commodity code was acquired from the customer service robot 10 (Act 82). If it is determined that a commodity code was acquired (Yes in Act 82), the processing proceeds to Act 83. On the other hand, if it is not determined that a commodity code was acquired (No in Act 82), the store device 20 ends an operation relating to the store cooperation processing.

If it is determined in Act 82 that a commodity code was acquired, the robot cooperation unit 2142 outputs a light emission instruction to an electronic shelf label of a relevant commodity (Act 83). Consequently, since the electronic shelf label of the relevant commodity emits light, the customer can easily find the commodity. Note that, if the customer service robot 10 left the store and the connection established in Act 81 was interrupted, the store device 20 stops the light emission of the electronic shelf label (not illustrated in FIG. 29). Thereafter, the store device 20 ends an operation relating to the store cooperation processing.

### (Flow of the Purchase Support Processing Performed by the Customer Service Support System)

A flow of the purchase support processing is explained with reference to FIG. 30. FIG. 30 is a flowchart illustrating an example of the flow of the purchase support processing.

The customer service robot 10 cooperates with the store device 20 and the server device 30 to thereby perform the purchase support processing. The store device 20 and the server device 30 acquire a result of processing performed by the customer service robot 10 at any time and update the contents of the various tables stored by the store device 20 and the server device 30.

The customer service robot 10 cooperates with the store device 20 and the server device 30 to thereby execute the purchase support processing. However, since explanation is complicated, only processing performed by the customer service robot 10 is explained with reference to FIG. 30.

The purchase supporting unit 1553 determines whether a commodity code was input (Act 90). Specifically, if a code symbol or a wireless tag was read on the basic operation screen Gi explained above, the purchase supporting unit 1553 determines that a commodity code was input. If it is determined that a commodity code was input (Yes in Act 90), the processing proceeds to Act 91. On the other hand, if it is not determined that the commodity code was input (No in Act 90), the processing proceeds to Act 101.

If it is determined in Act 90 that a commodity code was input, the purchase supporting unit 1553 causes the front display unit 132 to display the commodity screen Gj (Act 91).

Subsequently, the purchase supporting unit 1553 determines whether a recommendation request from the customer was made (Act 92). Specifically, if the operation piece Gjc was operated on the commodity screen Gj, the purchase supporting unit 1553 determines that the recommendation request was made. If it is determined that the recommendation request was made (Yes in Act 92), the processing proceeds to Act 93. On the other hand, if it is not determined that the recommendation request was made (No in Act 92), the processing proceeds to Act 94.

If it is determined in Act 92 that the recommendation request was made, the purchase supporting unit 1553 displays a recommended commodity on the commodity screen Gj. Note that, if a plurality of recommended commodities are present, one recommended commodity selected by selection operation of the customer is displayed on the commodity screen Gj (Act 93).

Subsequently, the purchase supporting unit 1553 determines whether a registration instruction for the commodity displayed on the commodity screen Gj was made (Act 94). Similarly, if it is not determined in Act 92 that the recommendation request was made, the purchase supporting unit 1553 determines whether a registration instruction for the commodity displayed on the commodity screen Gj was made (Act 94). Specifically, if detecting operation information of the operation piece Gjb displayed on the commodity screen Gj, the purchase supporting unit 1553 determines that the registration instruction for the commodity was made. If it is determined that the commodity registration instruction was made (Yes in Act 94), the processing proceeds to Act 95. On the other hand, if it is not determined that the commodity registration instruction was made (No in Act 94), the processing returns to Act 90. Note that, if the processing returns to Act 90, the basic operation screen Gi is displayed on the front display unit 132 of the customer service robot 10.

If it is determined in Act 94 that the commodity registration instruction was made, the purchase supporting unit 1553 performs commodity registration (Act 95). At this time, the purchase supporting unit 1553 registers the commodity in a state in which it is possible to identify whether the registered commodity is a store commodity or a provisional commodity. Thereafter, the processing returns to Act 90. Note that, at this time, the basic operation screen Gi is displayed on the customer service robot 10.

If the processing returns to Act 90 and it is not determined in Act 90 that a commodity code was input, the purchase supporting unit 1553 determines whether an instruction for virtual basket display was made (Act 101). Specifically, if the operation piece Gig explained above was operated on the basic operation screen Gi, the purchase supporting unit 1553 determines that the instruction for virtual basket display was made. If it is determined that the instruction for virtual basket display was made (Yes in Act 101), the processing proceeds to Act 102. On the other hand, if it is not determined that the instruction for virtual basket display was made (No in Act 101), the processing proceeds to Act 111.

If it is determined in Act 101 that the instruction for virtual basket display was made, the purchase supporting unit 1553 displays a list screen of registered commodities (not illustrated) on the front display unit 132 of the customer service robot 10 (Act 102).

Subsequently, the purchase supporting unit 1553 determines whether commodity selection was performed on the list screen of the registered commodities (Act 103). If it is determined that commodity selection was performed (Yes in Act 103), the processing proceeds to Act 104. On the other hand, if it is not determined that commodity selection was performed (No in Act 103), the processing proceeds to Act 105.

If it is determined in Act 103 that commodity selection was performed, the purchase supporting unit 1553 displays, on the front display unit 132 of the customer service robot 10, the commodity screen Gj on which a selected commodity is displayed (Act 104).

The purchase supporting unit 1553 determines whether settlement was instructed on the commodity screen Gj (Act 105). Specifically, if the operation piece Gih displayed on the commodity screen Gj was operated, the purchase supporting unit 1553 determines that settlement was instructed. If it is determined that settlement was instructed (Yes in Act 105), the processing proceeds to Act 112. On the other hand, if it is not determined that settlement was instructed (No in Act 105), the processing proceeds to Act 106.

If it is not determined in Act 105 that settlement was instructed, the purchase supporting unit 1553 determines whether a store leaving instruction was made from the customer (Act 106). Specifically, if the operation piece Gic was operated on the basic operation screen Gi or the commodity screen Gj, the purchase supporting unit 1553 determines that the store leaving instruction was made from the customer. If it is determined that the store leaving instruction was made from the customer (Yes in Act 106), the processing proceeds to Act 107. On the other hand, if it is not determined that the store leaving instruction was made from the customer (No in Act 106), the processing returns to Act 90.

If it is determined in Act 106 that the store leaving instruction was made from the customer, the purchase supporting unit 1553 determines whether all store commodities among the registered commodities were already settled (Act 107). If it is determined that all the store commodities were already settled (Yes in Act 107), the customer service robot 10 ends the purchase support processing, returns to the main routine illustrated in FIG. 26, and guides the customer to the next store. On the other hand, if it is not determined that all the store commodities among the registered commodities were already settled (No in Act 107), the processing proceeds to Act 108.

If it is not determined in Act 107 that all the store commodities among the registered commodities were already settled, the purchase supporting unit 1553 causes the customer service robot 10 to inform to that effect (Act 108). Specifically, the purchase supporting unit 1553 causes the light emitting unit 141 of the customer service robot 10 to emit light or performs, on the front display unit 132, display indicating that unsettled store commodities are present to thereby inform that the unsettled store commodities are present. Thereafter, the processing returns to Act 90. The customer performs settlement of the unsettled store commodity.

If the processing returns to Act 101 and it is not determined in Act 101 that the instruction for virtual basket display was made, the purchase supporting unit 1553 determines whether a settlement instruction was made (Act 111). Specifically, if the operation piece Gih was operated on the basic operation screen Gi or the commodity screen Gj, the purchase supporting unit 1553 determines that the settlement instruction was made from the customer. If it is determined that the settlement instruction was made (Yes in Act 111), the processing proceeds to Act 112. On the other hand, if it is not determined that the settlement instruction was made (No in Act 111), the processing proceeds to Act 121.

If it is determined in Act 111 that the settlement instruction was made, the purchase supporting unit 1553 displays a settlement method selection screen (not illustrated) on the front display unit 132 (Act 112). Choices such as “credit”, “cash”, “electronic money”, and “code settlement” are displayed on the settlement method selection screen. Note that, if it is determined in Act 105 that settlement was instructed, the processing in Act 112 is performed.

The purchase supporting unit 1553 receives selection of a choice on the settlement method selection screen (Act 113).

Subsequently, the purchase supporting unit 1553 executes the settlement instructed in Act 105 or Act 111 with the method received in Act 113 (Act 114).

Subsequently, the purchase supporting unit 1553 determines whether an instruction for a commodity receiving method was made from the customer (Act 115). Specifically, if a not-illustrated choice indicating “designate a receiving method” displayed on the front display unit 132 was operated, the purchase supporting unit 1553 determines that a receiving method was instructed. If it is determined that a commodity receiving method was instructed (Yes in Act 115), the processing proceeds to Act 116. On the other hand, if it is not determined that a commodity receiving method was instructed (No in Act 115), the processing returns to Act 106. Note that, if a receiving method was not instructed in Act 115, it is determined that the customer carries back a purchased commodity by himself or herself. In this case, the customer places the purchased commodity on the placing table 112 of the customer service robot 10 and causes the customer service robot 10 to convey the purchased commodity.

If it is determined in Act 115 that a commodity receiving method was instructed from the customer, the purchase supporting unit 1553 receives selection of a receiving method out of a commodity receiving method selection screen (not illustrated) displayed on the front display unit 132 (Act 116). Choices such as “send”, “receive at a counter”, “receive at a locker”, “receive at an exit”, and “receive at a parking lot” are displayed on the receiving method selection screen. The purchase supporting unit 1553 acquires a receiving method selected out of the choices. Note that, if a settled commodity is a provisional commodity, since the relevant commodity is sent later, only “send” and “receive at a counter” by visiting the store again as soon as a commodity arrives may be made selectable. On the other hand, if the settled commodity is a store commodity, all the choices explained above are made selectable.

The purchase supporting unit 1553 makes arrangement to receive the commodity with the receiving method selected in Act 116 (Act 117). Thereafter, the processing returns to Act 106.

If the processing returns to Act 111 and it is not determined in Act 111 that the settlement instruction was made, the purchase supporting unit 1553 determines whether an inquiry request was made (Act 121). Specifically, if the operation piece Gif was operated on the basic operation screen Gi or the commodity screen Gj, the purchase supporting unit 1553 determines whether an inquiry request was made from the customer. If it is determined that an inquiry request was made (Yes in Act 121), the processing proceeds to Act 122. On the other hand, if it is not determined that an inquiry request was made (No in Act 121), the processing returns to Act 106.

If it is determined in Act 121 that an inquiry request was made from the customer, the purchase supporting unit 1553 transmits inquiry information including the position and the like of the customer service robot 10 to the store device 20 (Act 122). Thereafter, the processing returns to Act 106.

Note that, in the store device 20 that received the inquiry information, the position and the like of the customer service robot 10 are notified to a terminal carried by a store clerk of the store, for example, according to control of the robot cooperation unit 2142 to urge the store clerk to attend the customer.

The customer service robot 10 may adjust a parking fee after shopping of the customer ended. At this time, for example, the purchase supporting unit 1553 calculates a parking time from the present time and a parking start time and calculates a parking fee corresponding to the parking time. The purchase supporting unit 1553 takes into account a discount of the parking fee based on a total amount of commodities purchased by the customer and, if adjustment of the parking fee is necessary, causes the customer to perform adjustment processing for the parking fee in short.

The embodiment is explained above. However, in the embodiment explained above, the programs to be executed by the devices including the customer service robot 10, the store device 20, the server device 30, the parking lot system 40, and the customer terminal 50 may be provided by being recorded in a computer-readable recording medium such as a CD-ROM. The programs to be executed by the devices may be provided by being stored on a computer connected to a network such as the Internet and downloaded through the network or may be provided through a network such as the Internet.

### (Action Effects of the Embodiment)

As explained above, the customer service robot 10 in the embodiment autonomously moves to support shopping of a customer in a commercial facility including a plurality of stores. The customer service robot 10 includes the operation mode setting unit 1545 (the moving form setting unit) that sets a moving form in moving while being accompanied by the customer to the leading mode (the first moving form) for leading the customer and moving along a set moving route or the following mode (the second moving form) for moving following the customer and the movement control unit 1548 that causes the customer service robot 10 to move, in the moving form set by the operation mode setting unit 1545, in a state in which the distance to the customer is kept constant. Therefore, it is possible to implement a customer service form matching a desire of a customer.

The customer service robot 10 in the embodiment further includes the imaging control unit 1546 that causes the front imaging unit 1431 (the first imaging unit), which images a front side of a moving direction, and the rear imaging unit 1432 (the second imaging unit), which images a rear side of the moving direction, to perform imaging and the customer detecting unit 1547 (the image processing unit) that, if the operation mode setting unit 1545 (the moving form setting unit) sets the leading mode (the first moving form), recognizes a position of the customer registered in advance out of an image captured by the rear imaging unit 1432 and, if the operation mode setting unit 1545 sets the following mode (the second moving form), recognizes the position of the customer registered in advance out of an image captured by the front imaging unit 1431. The movement control unit 1548 causes the customer service robot 10 to move in a state in which the distance between the customer recognized by the customer detecting unit 1547 and the customer service robot 10 is kept constant. Therefore, it is possible to surely specify the position of a customer irrespective of a moving form. Consequently, it is possible to move while keeping a positional relation with the customer constant.

The customer service robot 10 in the embodiment further includes the display control unit 1541 that causes the front display unit 132 (the first display unit) included on the front side of the customer service robot 10 and the rear display unit 115 (the second display unit) included on the rear side of the customer service robot 10 to display information corresponding to the moving form. Therefore, it is possible to display appropriate information corresponding to the positional relation with the customer.

In the customer service robot 10 in the embodiment, the operation mode setting unit 1545 (the moving form setting unit) sets the moving form of the customer service robot 10 to the following mode (the second moving form) if detecting that the customer entered the store and sets the moving form of the customer service robot 10 to the leading mode (the first moving form) if detecting that the customer left the store. Therefore, in the store, it is possible to cause the customer to perform shopping at a pace of the customer.

The customer service robot 10 in the embodiment further includes the setting handover unit 1552 that hands over at least features of the customer, the moving route, and transaction information of the customer at that point in time registered in the customer service robot 10 to another customer service robot 10. The movement control unit 1548 of the customer service robot 10, the information of which was handed over, continues a customer service for the customer based on the handed over information. Therefore, it is possible to perform the customer service without interrupting a customer service action irrespective of the structure of a commercial facility.

Although the embodiment is explained above, the embodiment is an illustration and is not intended to limit the scope of disclosure. The new embodiment can be implemented in other various forms. Various omissions, substitutions, and changes can be made without departing from the gist of the disclosure. The embodiment and modifications thereof are included in the scope and the gist of the disclosure and included in the disclosure described in the claims and a scope of equivalents of the disclosure.

What is claimed is:

1. A customer service robot that autonomously moves to support shopping of a customer in a commercial facility including a plurality of stores, the customer service robot comprising:
a moving form setting component configured to set a moving form in moving while being accompanied by the customer to a first moving form for leading the customer and moving along a set moving route or a second moving form for moving following the customer; and
a movement controller configured to cause the customer service robot to move, in the moving form set by the moving form setting component, in a state in which a distance to the customer is kept constant.

2. The customer service robot according to claim 1, further comprising:
an imaging controller configured to cause a first imaging component, which images a front side of a moving direction, and a second imaging component, which images a rear side of the moving direction, to perform imaging; and
an image processing component configured to, if the moving form setting component sets the first moving form, recognize a position of the customer registered in advance out of an image captured by the second imaging component and, if the moving form setting component sets the second moving form, recognize the position of the customer registered in advance out of an image captured by the first imaging component, wherein
the movement controller causes the customer service robot to move in a state in which a distance between the customer recognized by the image processing component and the customer service robot is kept constant.

3. The customer service robot according to claim 1, further comprising a display controller configured to cause the first display component included on a front side of the customer service robot and the second display component included on a rear side of the customer service robot to display information corresponding to the moving form.

4. The customer service robot according to claim 1, wherein the moving form setting component sets the moving form of the customer service robot to the second moving form if detecting that the customer entered the store and sets the moving form of the customer service robot to the first moving form if detecting that the customer left the store.

5. The customer service robot according to claim 1, further comprising a setting handover component configured to hand over at least features of the customer, the moving route, and transaction information of the customer at that point in time registered in the customer service robot to another customer service robot, wherein
the movement controller of the customer service robot, the information of which was handed over, continues a customer service for the customer based on the handed over information.

6. The customer service robot according to claim 1, further comprising a placing table that projects from the customer service robot so that a commodity can be placed thereon.

7. The customer service robot according to claim 1, further comprising a light emitting component configured to emit a plurality of colors and switch a light emission color to thereby inform various states of the customer service robot or a commodity purchase state.

8. The customer service robot according to claim 2, wherein the first imaging component is further configured to recognize a barcode associated with a commodity.

9. A method for a customer service robot that autonomously moves to support shopping of a customer in a commercial facility including a plurality of stores, the method comprising:
setting a moving form in moving while being accompanied by the customer to a first moving form for leading the customer and moving along a set moving route or a second moving form for moving following the customer; and
causing the customer service robot to move, in the moving form set by a moving form setting component, in a state in which a distance to the customer is kept constant.

10. The method according to claim 9, further comprising:
causing a first imaging component, which images a front side of a moving direction, and a second imaging component, which images a rear side of the moving direction, to perform imaging with an imaging controller;
if the moving form setting component sets the first moving form, recognizing, with an image processing component, a position of the customer registered in advance out of an image captured by the second imaging component and, if the moving form setting component sets the second moving form, recognizing the position of the customer registered in advance out of an image captured by the first imaging component; and
causing the customer service robot to move in a state in which a distance between the customer recognized by the image processing component and the customer service robot is kept constant.

11. The method according to claim 9, further comprising causing the first display component included on a front side of the customer service robot and the second display component included on a rear side of the customer service robot to display information corresponding to the moving form.

12. The method according to claim 9, further comprising setting the moving form of the customer service robot to the second moving form if detecting that the customer entered the store and setting the moving form of the customer service robot to the first moving form if detecting that the customer left the store.

13. The method according to claim 9, further comprising:
handing over at least features of the customer, the moving route, and transaction information of the customer at that point in time registered in the customer service robot to another customer service robot; and
continuing a customer service for the customer based on the handed over information.

14. The method according to claim 9, further comprising emitting a plurality of colors and switching a light emission color to thereby inform the customer of various states of the customer service robot or a commodity purchase state.

15. The method according to claim 10, further comprising recognizing a barcode associated with a commodity by the first imaging component.

16. A customer service support system, comprising:
a plurality of customer service robots, each customer service robot autonomously moves to support shopping of a customer in a commercial facility including a plurality of stores, each customer service robot comprising:
a moving form setting component configured to set a moving form in moving while being accompanied by the customer to a first moving form for leading the customer and moving along a set moving route or a second moving form for moving following the customer; and
a movement controller configured to cause the customer service robot to move, in the moving form set by the moving form setting component, in a state in which a distance to the customer is kept constant;
a store device; and
a customer terminal,
wherein the customer service robot, the store device, and the customer terminal are connected to a network.

17. The customer service support system according to claim 16, wherein the store device is a POS terminal or a store server provided in each of the stores present in the commercial facility.

18. The customer service support system according to claim 16, further comprising a parking lot system configured to manage entering and leaving states and parking positions of vehicles.

19. The customer service according to claim 16, wherein the customer terminal is a smartphone or a tablet terminal carried by a customer.

20. The customer service support system according to claim 16, wherein each customer service robot further comprises:
an imaging controller configured to cause a first imaging component, which images a front side of a moving direction, and a second imaging component, which images a rear side of the moving direction, to perform imaging; and
an image processing component configured to, if the moving form setting component sets the first moving form, recognize a position of the customer registered in advance out of an image captured by the second imaging component and, if the moving form setting component sets the second moving form, recognize the position of the customer registered in advance out of an image captured by the first imaging component, wherein
the movement controller causes the customer service robot to move in a state in which a distance between the customer recognized by the image processing component and the customer service robot is kept constant.
